(19) United States
(12) Patent Application Publication
(10) Pub. No.: US 2026/0154188 A1
(43) Pub. Date: Jun. 4, 2026

(54) DRIVING SYSTEM AND TEST METHOD

(71) Applicant: DENSO CORPORATION, Kariya-city (JP)

(72) Inventor: Atsushi BABA, Kariya-city (JP)

(21) Appl. No.: 19/462,634

(22) Filed: Jan. 28, 2026

Related U.S. Application Data
(63) Continuation of application No. PCT/JP2024/025492, filed on Jul. 16, 2024.

(30) Foreign Application Priority Data
Aug. 4, 2023 (JP) 2023-128126

(51) Int. Cl. G06F 11/3668; B60W 60/00

(52) U.S. Cl. CPC G06F 11/3688; B60W 60/0051; G06F 11/3696

(57) ABSTRACT

A driving system to be mounted on a vehicle includes at least one processor; and at least one storage medium configured to store at least one piece of software. Automated driving is enabled by operating the software by the processor in a manner of allowing authority transfer between a system itself and a user. The processor is configured to execute requesting consent of the user to perform a test on test software for improving the software, and operating the test software when the consent of the user is acquired. In requesting consent of the user, the processor requests the consent of the user in conjunction with a timing of the authority transfer.

### CROSS REFERENCE TO RELATED APPLICATIONS

The present application is a continuation application of International Patent Application No. PCT/JP2024/025492 filed on Jul. 16, 2024 which designated the U. S. and claims the benefit of priority from Japanese Patent Application No. 2023-128126 filed on Aug. 4, 2023. The entire disclosures of all of the above applications are incorporated herein by reference.

### TECHNICAL FIELD

The disclosure in this description relates to a technique for improving performance of a driving system in a vehicle.

### BACKGROUND

A related art discloses a system for driving a vehicle. In this system, a safety model such as a driving policy and an RSS model is implemented as software, making a system applicable to several millions of vehicles conforming to the requirements of safety statements.

### SUMMARY

According to an aspect of the present disclosure, a driving system to be mounted on a vehicle includes at least one processor, and at least one storage medium configured to store at least one piece of software. Automated driving is enabled by operating the software by the processor in a manner of allowing authority transfer between a system itself and a user. The processor is configured to execute requesting consent of the user to perform a test on test software for improving the software, and operating the test software when the consent of the user is acquired. In requesting consent of the user, the processor may request the consent of the user in conjunction with a timing of the authority transfer.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an example of a schematic configuration of a driving system;

FIG. 2 is a diagram illustrating an example of a hardware configuration of the driving system;

FIG. 3 is a diagram illustrating an example of a functional configuration of the driving system;

FIG. 4 is a diagram illustrating a longitudinal safety distance;

FIG. 5 is a diagram illustrating a longitudinal safety distance;

FIG. 6 is a diagram illustrating a lateral safety distance;

FIG. 7 is a diagram illustrating a lane-based coordinate system;

FIG. 8 is a flowchart illustrating a process performed by the driving system;

FIG. 9 is a diagram illustrating state transition of the driving system;

FIG. 10 is a diagram illustrating state transition of the driving system at level 3;

FIG. 11 is a diagram illustrating authority transfer during a failure of the driving system at level 3;

FIG. 12 is a diagram illustrating authority transfer during an ODD exit of the driving system at level 3;

FIG. 13 is a diagram illustrating authority transfer during a failure of the driving system at level 4;

FIG. 14 is a diagram illustrating authority transfer during an ODD exit of the driving system at level 4;

FIG. 15 is a diagram illustrating an example of a schematic configuration of a management system;

FIG. 16 is a flowchart illustrating a process performed by the management system;

FIG. 17 is a flowchart illustrating a process performed by the management system;

FIG. 18 is a diagram illustrating a test consent during the ODD exit of the driving system at level 3;

FIG. 19 is a diagram illustrating a test consent during the ODD exit of the driving system at level 4;

FIG. 20 is a flowchart illustrating a process performed by the driving system;

FIG. 21 is a flowchart illustrating a process performed by the driving system;

FIG. 22 is a diagram illustrating an example of a test using a shadow-mode;

FIG. 23 is a diagram illustrating an example of a test using a redundant system;

FIG. 24 is a diagram illustrating a user interface for setting a test mode;

FIG. 25 is a diagram illustrating an example of another test;

FIG. 26 is a diagram illustrating an example of another test; and

FIG. 27 is a diagram illustrating an example of another test.

### DETAILED DESCRIPTION

It is required to execute a verification and validation (V&V) process and execute an improvement on such a driving system. This improvement is also required for vehicles shipped to the market.

The present disclosure provides a driving system and a test method suitable for improving performance.

According to one aspect of the present disclosure, a driving system to be mounted on a vehicle is provided. The driving system includes: at least one processor; and at least one storage medium configured to store at least one piece of software. Automated driving is enabled by operating the software by the processor in a manner of allowing authority transfer between a system itself and a user. The processor is configured to execute requesting consent of the user to perform a test on test software for improving the software, and operating the test software when the consent of the user is acquired. In requesting consent of the user, the processor requests the consent of the user in conjunction with a timing of the authority transfer.

According to such an aspect, the consent of the user to the conduction of the test of the test software is requested in conjunction with the timing of the authority transfer. That is, the consent to the test software to be used after the authority transfer between the driving system and the user can be acquired together with the authority transfer. Therefore, the validity of conducting the test can be ensured while reducing the inconvenience felt by the user for acquiring the consent. Therefore, a driving system suitable for conducting an improvement in performance can be provided.

According to one aspect of the present disclosure, a test method for conducting, in a driving system to be mounted on a vehicle that includes at least one processor and at least one storage medium configured to store at least one piece of software, and that is configured to enable automated driving by operating the software by the processor in a manner of allowing authority transfer between a system itself and a user, a test regarding the software by the processor, is provided. The test method includes: requesting, in conjunction with a timing of the authority transfer, consent of the user to perform a test on test software for improving the software; acquiring the consent of the user by sensing an operation of the user on an operation input device of the vehicle in response to the request; operating the test software when the consent of the user is acquired; and prohibiting an operation of the test software when the consent of the user is not acquired.

According to such an aspect, the consent of the user to the conduction of the test of the test software is requested in conjunction with the timing of the authority transfer. That is, the consent to the test software to be used after the authority transfer between the driving system and the user can be acquired together with the authority transfer. Therefore, the validity of conducting the test can be ensured while reducing the inconvenience felt by the user for acquiring the consent. Therefore, a test method suitable for improving performance can be provided.

Hereinafter, multiple embodiments will be described with reference to the drawings. Duplicate description may be omitted by assigning the same reference numerals to the corresponding elements in each embodiment. When only a part of a configuration is described in each embodiment, the configurations of the other embodiments described above can be applied to the other parts of the configuration. In addition, configurations specified in the description of each embodiment can be combined, and especially, configurations of multiple embodiments can be partially combined even though not specified herein so long as no problem occurs in the combination thereof.

In the following multiple embodiments, contents of “Safety First for Automated Driving” Tech. Rep., 2019, by Aptiv, Audi, Baidu, BMW, Continental, Daimler, FCA, here, Infineon, Intel, and Volkswagen, contents of “On a formal model of safe and scalable self-driving cars”, arXiv: 1708.06374, 2017, by S. Shalev-Shwartz, S. Shammah, and A. Shashua, contents of “The Safety Force Field” Technical Report, 2019, by David Nister, Hon-Leung Lee, Julia Ng, Yizhou Wang, contents of IEEE 2846-2022 are incorporated by reference in their entirety.

### Description of Terms

The following describes terms related to this disclosure. This description is included in the embodiments of this disclosure.

A road user may be a traffic participant on or adjacent to an active road for the purpose of moving from a certain place to another place.

A dynamic driving task (DDT) may be a real-time operation functionality and a real-time strategic functionality for operating a vehicle in traffic. The dynamic driving task may be all real-time operation functionalities and real-time strategic functionalities for operating the vehicle on the road.

An automated driving system (ADS) may be a batch of hardware and software capable of continuously executing the entire DDT regardless of whether the automated driving system is limited to a specific operational design domain.

ADS functionality (ADS feature) may be design-specific functionality of the ADS in a specific ODD at a predetermined automated driving level.

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other system using takeover/fallback states and associated use cases. The DDT fallback may be a response by the user for executing the DDT or achieving an MRC after the occurrence of a system failure related to the DDT performance or during deviation from the ODD, or a response by the ADS for achieving the MRC when placed in the same situation.

The minimal risk condition (MRC) may be a vehicle state in order to reduce the risk, when a predetermined trip cannot be completed. The minimal risk condition may be a stable stop state that the user or the ADS brings to the vehicle after the DDT fallback is executed in order to reduce the risk of an accident when the predetermined trip cannot or should not be continued.

The operational design domain (ODD) may be a specific condition which is designed such that a predetermined (automated) driving system functionalities. The operational design domain is an operation condition specially designed such that a predetermined ADS or a functionality thereof functions, and includes, but is not limited to, the presence or absence of requirements of environmental, geography, and time zone restrictions, and/or certain traffic/road properties.

Safety of the intended functionality (SOTIF) may mean absence of an unreasonable risk caused by functional insufficiency for an intended functionality or implementation thereof.

A driving policy may be a strategy and a rule defining a control action at a vehicle level.

A situation is a factor that can affect a behavior of a system, and may include traffic situations, weather, and the behavior of the ego-vehicle.

A scenario may be a description of the temporal relationships between several scenes in a series of scenes, including goals and values in a specific situation influenced by actions and events. The scenario may be a description of consecutive activities in time series in which a vehicle as a main-object, all external environments thereof, and interactions thereof in a process of executing a specific driving task are integrated.

A safety-relevant object may be any moving or static object that may be relevant to the safety performance of the DDT.

The term “reasonably foreseeable” may mean being technically reliable and having a credible or measurable occurrence rate.

A triggering condition may be a specific condition of a scenario functioning as a trigger for a response that is a response of a subsequent system and that contributes to inability to prevent, detect, and reduce hazardous behaviors and reasonably foreseeable indirect misuse.

The safety-related model may be representation of a safety-related aspect of the driving action based on assumptions on the reasonably foreseeable behavior of other road users. The safety-related model may be an on-board or off-board checker or an on-board or off-board safety analysis device, a mathematical model, a set of more conceptual rules, a set of scenario-based behavior, or a combination thereof.

A formal model may be a model represented in a formal representation used for system performance verification.

A safety envelope may be a set of restrictions and conditions that are designed for a (automated) driving system to operate as a target for a constraint or a control in order to maintain an operation at an acceptable risk level. The safety envelope may be a general concept that can be used to deal with all principles on which the driving policy can be based. According to this concept, an ego-vehicle operated by the (automated) driving system can have one or multiple boundaries around the ego-vehicle.

A response time may be a time required for the road user to sense a specific stimulus and start executing a response (braking, steering, acceleration, stopping, or the like) in a predetermined scenario.

The risk acceptance criteria/criterion are/is criteria/a criterion indicating that there is no unreasonable level of risk, and may be, for example, a physical parameter defining when a specific behavior is regarded as a dangerous behavior, the maximum number of accidents per hour, the lowest level reasonably executable, or the like. as a hazardous behavior, the maximum number of incidents per hour, as low as reasonably practicable.

The positive risk balance may be a criterion to demonstrate that a technical solution achieves an acceptable level of residual risk.

A vulnerable road user (VRU) may be a road user not in vehicles such as a car, a public transport agency, or a train. The vulnerable road user may be an unprotected road user, such as a motorcyclist, a cyclist, a pedestrian, or a person with a disability or with reduced mobility and orientation.

A proper response may be an action that is significant to avoid and ameliorate a hazardous situation in a reasonably foreseeable scenario in which other safety-relevant objects are operating within an assumption range.

The object and event detection and response (OEDR) may be a sub-task of the DDT including monitoring the driving environment and executing an appropriate response to such an object or event.

The minimal risk maneuver (MRM) may be a movement of the vehicle instructed by the automated driving system during the DDT fallback to achieve the MRC.

### First Embodiment

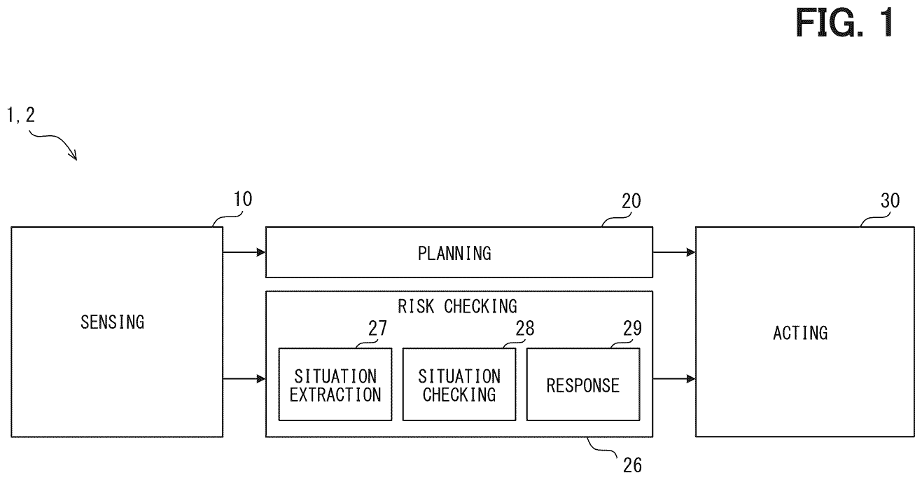

A driving system 2 of a first embodiment illustrated in FIG. 1 implements functionalities related to driving of a vehicle 1. A part or all of the driving system 2 is mounted on the vehicle 1. The vehicle 1 may be referred to as an ego-vehicle, a host vehicle, or the like. The vehicle 1 may be configured to communicate with another vehicle or the like directly or indirectly via communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. The automated driving may be referred to as autonomous driving by the driving system 2. Levels of the driving are classified in accordance with a range or the like of tasks executed by a human driver, among all dynamic driving tasks (DDTs). The automation level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 assists the driver. Level 2 indicates that driving is partially automated.

At level 3 or higher, the driving system 2 performs the entire DDT while the ADS functionality (ADS feature) is operating. Levels 3 to 5 may be classified as so-called automated driving. Systems capable of executing driving at level 3 or higher may be referred to as automated driving systems (ADS). A vehicle on which an automated driving system is mounted or a vehicle capable of executing driving at level 3 or higher may be referred to as an automated vehicle/autonomous vehicle (AV).

Level 3 indicates that driving is conditionally automated. The automated driving system at level 3 executes the DDT but does not execute the DDT fallback. That is, the DDT fallback is executed by a driver who is ready for fallback. Level 4 indicates that driving is highly automated. The automated driving system at level 4 executes the DDT and the DDT fallback. The automated driving system at level 4 can cause the driver to take over the DDT after reaching the minimal risk condition (MRC) by executing the DDT fallback or the like. Level 5 indicates that driving is fully automated. The takeover of the DDT between the driving system 2 and the human driver is also referred to as authority transfer.

The conditions for executing automated driving at levels 3 and 4 may include some or all of the conditions indicated by the operational design domain (ODD). For example, the ADS functionality may be defined within the range of ODD. The driving system 2 described in the present embodiment is a driving system capable of executing automated driving at level 3 or 4.

### (Driving System Overview)

An architecture of the driving system 2 is selected such that an efficient safety of the intended functionality (SOTIF) process can be implemented. For example, the architecture of the driving system 2 may be configured based on a sense-plan-act model. The sense-plan-act model includes a sense element, a plan element, and an act element, as main system elements. The sense element, the plan element, and the act element interact with one another. The sense may be replaced with perception, the plan may be replaced with determination, and the act may be replaced with control, respectively.

In such a driving system 2, at a functional level (in other words, from a functional perspective), a sensing functionality, a planning functionality, and an acting functionality are implemented. At a technical level (in other words, a technical perspective), at least multiple sensors 40 corresponding to the sensing functionality, at least one processing system 50 corresponding to the planning functionality, and multiple motion actuators 60 corresponding to the acting functionality are implemented.

Specifically, a sensing unit 10 as a functional block for implementing the sensing functionality mainly using the multiple sensors 40, a processing system 50 that processes sense information of the multiple sensors 40, and a processing system 50 that generates an environment model based on information of the multiple sensors 40 may be constructed in the driving system 2. A planning unit 20 and a risk checking unit 26 as functional blocks that implement the planning functionality mainly using the processing system 50 may be constructed in the driving system 2. An acting unit 30 as a functional block for implementing the acting functionality mainly using multiple motion actuators 60 and at least one processing system that outputs an operation signal of the multiple motion actuators 60 may be constructed in the driving system 2.

The sensing unit 10 may be implemented in a form of a sensing system serving as a subsystem that is provided to be distinguishable from the planning unit 20 and the acting unit 30. The planning unit 20 may be implemented in a form of a planning system as a subsystem that is provided to be distinguishable from the sensing unit 10 and the acting unit 30. The planning system may include the risk checking unit 26. The acting unit 30 may be implemented in a form of an acting system serving as a subsystem that is provided to be distinguishable from the sensing unit 10 and the planning unit 20. The sensing system, the planning system, and the acting system may constitute independent components. The subsystem here may be replaced with a module, a unit, a device, or the like.

The sensing unit 10 serves as the sensing functionality including localization (for example, estimation of position) of a road user such as the vehicle 1 and another vehicle. The sensing unit 10 senses an external environment, an internal environment, and a vehicle state of the vehicle 1 and further, a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control action. The acting unit 30 executes the control action derived by the planning unit 20.

The risk checking unit 26 implements a risk checking functionality of checking a risk occurring in the vehicle 1. The risk checking unit 26 may be implemented independently of the planning unit 20 as illustrated in FIG. 1, or may be implemented as a part of the planning functionality of the planning unit 20.

### (Physical Architecture Overview)

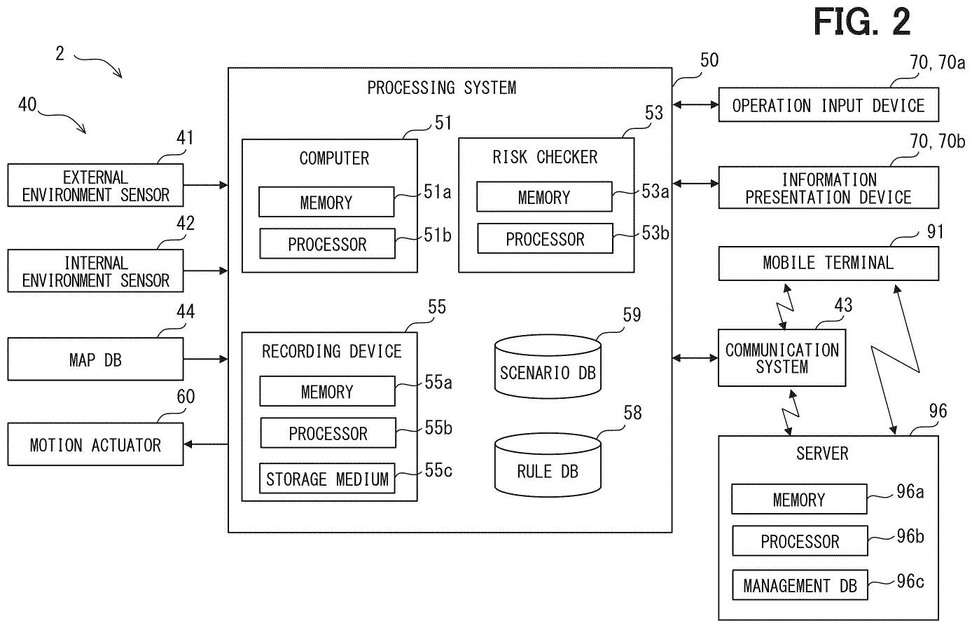

An example of a physical architecture of the driving system 2 will be described with reference to FIG. 2. The driving system 2 includes the multiple sensors 40, the multiple motion actuators 60, multiple HMI devices 70, and at least one processing system 50. These elements can communicate with each other through one or both of a wireless connection and a wired connection. These elements may be capable of communicating with each other through, for example, an in-vehicle network such as a CAN (registered trademark).

The multiple sensors 40 include one or multiple external environment sensors 41. The multiple sensors 40 may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 of a target object detection type include a camera, a light detection and ranging/laser imaging detection and ranging (LiDAR), a laser radar, a millimeter wave radar, an ultrasonic sonar, and the like. Typically, a combination of multiple types of external environment sensors 41 may be mounted to monitor directions including a front direction, a side direction, and a rear direction of the vehicle 1.

The external environment sensor 41 may detect a state of an atmosphere or a state of weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereinafter, a motion physical quantity) related to a vehicle motion in the internal environment of the vehicle 1. Examples of the internal environment sensor 42 of a motion physical quantity detection type include a velocity sensor, an acceleration sensor, a gyro sensor, and the like. The internal environment sensor 42 may detect a state of an occupant in the internal environment of the vehicle 1. The internal environment sensor 42 of an occupant detection type is, for example, an actuator sensor, a sensor monitoring a user (for example, a driver) and a system thereof, a biometric sensor, a seating sensor, or an in-vehicle device sensor. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive communication signals to and from an external system (for example, a server 96) present in the external environment of the vehicle 1. A communication device of a V2X type in the communication system 43 is, for example, a dedicated short range communications (DSRC) communication device, or a cellular V2X (C-V2X) communication device. Examples of the communication with a V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of the V2X communication, including the V2I communication, may adopt an architecture defined in ISO 21217, ETSI TS 102 940-943, IEEE 1609, or the like.

The communication system 43 may transmit and receive a communication signal to and from the internal environment of the vehicle 1, for example, with a mobile terminal 91 such as a smartphone present in the vehicle. A communication device of a terminal communication type in the communication system 43 is, for example, a Bluetooth (registered trademark) device, a Wi-Fi (registered trademark) device, or an infrared communication device.

The map DB 44 is a database for storing map data usable in the driving system 2. The map DB 44 includes at least one type of non-transitory tangible storage medium of, for example, a semiconductor memory, a magnetic medium, or an optical medium. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high definition map having a high level of definition mainly used for an automated driving system. The map DB 44 may include a database of a parking lot map including specific parking lot information, for example, parking space markings information, used for automated parking or parking support.

The map DB 44 appropriate to the driving system 2 acquires and stores the latest map data through, for example, communication with a map server via the communication system 43 of a V2X type. The map data is converted into two-dimensional or three-dimensional data as data indicating the external environment of the vehicle 1. The map data may include, for example, road data representing at least one type among positional coordinates, a shape, and a road surface condition of a road structure and a standard roadway. The map data may include marking data representing at least one type of, for example, a road sign, a road display, and a positional coordinate and a shape of a lane marking attached to a road. The marking data included in the map data may represent, for example, a traffic sign, an arrow marking, a lane marking, a stop line, a direction sign, a landmark beacon, a business sign, or a change in a line pattern of a road among target objects. The map data may include structure data representing at least one type of positional coordinates, a shape, and the like of a building and a traffic light facing the road, for example. The marking data included in the map data may represent, for example, a streetlight, a road edge, a reflecting plate, or a pole among the target objects.

The motion actuator 60 is capable of controlling a vehicle motion based on an input control signal. The motion actuator 60 of a driving type is a power train including, for example, at least one type among an internal combustion engine, a drive motor, and the like. The motion actuator 60 of a braking type is, for example, a brake actuator. The motion actuator 60 of a steering type is, for example, a steering.

Multiple human machine interface (HMI) devices 70 may be mounted in the vehicle 1. The HMI device 70 implements a human machine interaction, which is an interaction between a user of the vehicle 1 and the driving system 2. Some of the multiple HMI devices 70, which implement an operation input functionality for the occupant, may be a part of the sensing unit 10. Some of the multiple HMI devices 70, which implement an information presentation functionality, may be a part of the acting unit 30. Meanwhile, the functionality implemented by the HMI device 70 may be provided as a functionality independent of the sensing functionality, the planning functionality, and the acting functionality.

The HMI device 70 may be an operation input device 70a capable of inputting an operation by the user to transmit the will or intention of the user of the vehicle 1 to the driving system 2. The HMI device 70 of an operation input type, that is, the operation input device 70a, is, for example, an accelerator pedal, a brake pedal, a shift lever, a steering wheel, a turn signal lever, a mechanical switch, and a touch panel of a navigation unit or the like. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be an information presentation device 70b that presents information such as visual information, auditory information, and cutaneous sensory information to the user of the vehicle 1. The HMI device 70 of a visual information presentation type, that is, the information presentation device 70b, is, for example, a combination meter, a graphic meter, the navigation unit, a center information display (CID), a head-up display (HUD), and an illumination unit. The HMI device 70 of an auditory information presentation type is, for example, a speaker and a buzzer. The HMI device 70 of a cutaneous sensory information presentation type is, for example, a vibration unit of the steering wheel, a vibration unit of a driver's seat, a reaction force unit of the steering wheel, a reaction force unit of the accelerator pedal, a reaction force unit of the brake pedal, and an air conditioning unit.

The HMI device 70 may implement an HMI functionality in cooperation with the mobile terminal 91 such as a smartphone by communicating with the terminal through the communication system 43. For example, the HMI device 70 may present information acquired from a smartphone to the user. For example, an operation input to the smartphone may be used as an alternative to an operation input to the HMI device 70.

At least one processing system 50 is provided. For example, the processing system 50 may be an integrative processing system that executes a process related to the sensing functionality, a process related to the planning functionality, and a process related to the acting functionality in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70.

For example, the processing system 50 may include each of at least one processing unit corresponding to the process related to the sensing functionality, at least one processing unit corresponding to the process related to the planning functionality, and at least one processing unit corresponding to the process related to the acting functionality.

The processing system 50 includes a communication interface for an outside, and is connected to at least one type of elements related to the process performed by the processing system 50 among each sensor, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may combine multiple dedicated computers 51 to implement a functionality such as the sensing functionality, the planning functionality, and the acting functionality.

For example, the dedicated computer 51 constituting the processing system 50 may be an integrated ECU that integrates driving functionalities of the vehicle 1. The dedicated computer 51 constituting the processing system 50 may be a determination ECU that determines a DDT. The dedicated computer 51 constituting the processing system 50 may be a monitoring ECU that monitors driving of the vehicle 1. The dedicated computer 51 constituting the processing system 50 may be an evaluation ECU that evaluates driving of the vehicle 1. The dedicated computer 51 constituting the processing system 50 may be a navigation ECU that navigates a travel route of the vehicle 1.

The dedicated computer 51 constituting the processing system 50 may be a locator ECU that estimates a position of the vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the vehicle 1. The dedicated computer 51 constituting the processing system 50 may be an HMI control unit (HCU) that integrally controls the HMI devices 70. The dedicated computer 51 constituting the processing system 50 may be, for example, at least one external computer that is provided in an external center or the mobile terminal 91 that enables communication via the communication system 43.

The dedicated computer 51 constituting the processing system 50 includes at least one memory 51a and at least one processor 51b. The memory 51a may be, for example, at least one type of non-transitory tangible storage medium, such as a semiconductor memory, a magnetic medium, and an optical medium, which non-temporarily stores a computer program, data, and the like that can be read by the processor 51b. For example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 constituting the processing system 50 may be a system on a chip (SoC) in which the memory 51a, the processor 51b, and an interface are integrally implemented on one chip, or at least one SoC may be provided as an element of the dedicated computer 51.

The processing system 50 may include at least one database for executing the DDT. The database may include, for example, a non-transitory tangible storage medium of at least one type of a semiconductor memory, a magnetic medium, and an optical medium, and an interface for accessing the storage medium.

The database may be a scenario database (hereinafter, referred to as “scenario DB”) 59. The database may be a rule database (hereinafter, rule DB) 58. At least one of the scenario DB 59 and the rule DB 58 may not be provided in the processing system 50, but may be provided independently in the driving system 2. At least one of the scenario DB 59 and the rule DB 58 may be provided in an external system present in an external environment and configured to be accessible from the processing system 50 via the communication system 43.

The scenario DB 59 has a scenario catalog in which multiple scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is set based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model to be described below (for example, the five principles of an RSS model). The plurality of rules may include a traffic rule. The traffic rule may be a rule defined in the Road Traffic Law, or may be a rule based on national or regional customs.

The rules such as the traffic rules stored in the rule DB 58 may be positioned as the information provided from the sensing unit 10 to the planning unit 20 by the sensing functionality, similarly to the map information acquired from the map DB 44.

The processing system 50 may also include at least one recording device 55 that records at least one of the sensing information, planning information, and action information of the driving system 2. The recording device 55 may include at least one large-capacity storage medium 55c. The storage medium 55c may be at least one type of non-transitory tangible storage medium among, for example, a semiconductor memory, a magnetic medium, and an optical medium.

The storage medium 55c may be mounted on a substrate in a form that is not easily detachable or replaceable, and in this form, for example, an embedded Multi Media Card (eMMC) or the like using a flash memory may be adopted. At least one of the storage media 55c may be in a form that is detachable and replaceable with respect to the recording device 55, and in this form, for example, an SD card or the like may be adopted.

The recording device 55 may have a functionality of selecting information to be recorded from among the sensing information, the planning information, and the action information. In this case, the recording device 55 may include a dedicated computer.

The dedicated computer provided in the recording device 55 has at least one memory 55a and at least one processor 55b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 55a, the processor 55b, and an interface are integrally implemented on one chip, or at least one SoC may be provided as an element of the dedicated computer.

The recording device 55 may access the storage medium 55c, and execute recording in accordance with a data writing command from each unit of the driving system 2. The recording device 55 may determine information transmitted to the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system present in the external environment, and configured to be accessible from the processing system 50 via the communication system 43.

The processing system 50 may include at least one risk checker 53.

The risk checker 53 may be one aspect of on-board implementation of responsibility sensitive safety (RSS) as a safety model. The risk checker 53 may be an on-board checker for the planning functionality implemented by the dedicated computer 51. The risk checker 53 implements, by hardware independent of the planning unit 20, the risk checking unit 26 that implements the risk checking functionality.

The risk checker 53 may be configured mainly with a dedicated computer having at least one memory 53a and at least one processor 53b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 53a, the processor 53b, and an interface are integrally implemented on one chip, or at least one SoC may be provided as an element of the dedicated computer.

As described above, the processing system 50 includes the memories 51a, 53a, and 55a that store software. The processors 51b, 53b, and 55b are configured to implement automated driving by operating software so that authority transfer can be implemented between the system itself and the user. The software herein may include a computer program itself used in the driving system 2. The software herein may include an algorithm in the computer program used in the driving system 2. The software herein may include parameters in the computer program used in the driving system 2. The software herein may include an AI or a trained model, such as a neural network, used in the driving system 2.

### (Outline of Logical Architecture in Automated Driving)

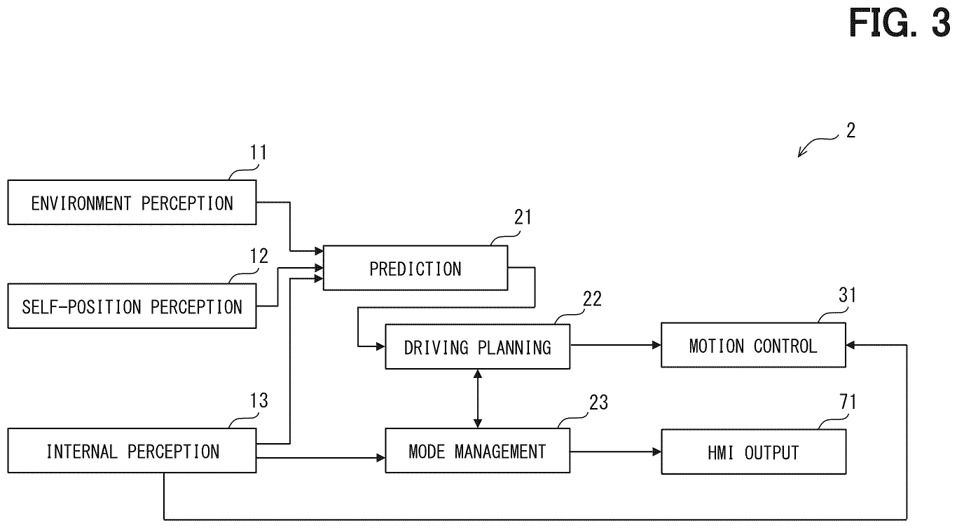

Next, an example of a logical architecture of the driving system 2 will be described with reference to FIG. 3. The description herein will focus on a process performed by a computer program executed during automated driving at level 3 or higher. The sensing unit 10 may include an environment perception unit 11, a self-position perception unit 12, and an internal perception unit 13 as processing units for implementing, by executing a computer program by the processor, sub-functionalities obtained by further classifying the sensing functionalities.

The environment perception unit 11 individually processes information (referred to as sensor data in some cases) on an external environment acquired from each sensor 40 and implements a functionality of perceiving the external environment including a target object, other road users, and the like. The environment perception unit 11 processes detection data detected by each external environment sensor 41 individually. The detection data may be detection data provided from, for example, a millimeter wave radar, a sonar, or a LiDAR. The environment perception unit 11 may generate relative position data including a direction, a size, and a distance of an object with respect to the vehicle 1, from raw data detected by the external environment sensor 41.

The detection data may be image data provided from, for example, a camera or a LIDAR. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

The environment perception unit 11 processes information acquired through a V2X functionality of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 conducts localization of the vehicle 1. The self-position perception unit 12 acquires global position data of the vehicle 1 from the communication system 43 (for example, a GNSS receiver). In addition, the self-position perception unit 12 may acquire position information of the target object extracted by the environment perception unit 11. The self-position perception unit 12 acquires map information from the map DB 44. The self-position perception unit 12 integrates these pieces of information to estimate a position of the vehicle 1 on a map.

The internal perception unit 13 implements a functionality of perceiving a vehicle state by processing detection data detected by each internal environment sensor 42. The vehicle state may include a state of a motion physical quantity of the vehicle 1 detected by a velocity sensor, an acceleration sensor, a gyro sensor, or the like. The vehicle state may include at least one type of a state of a user, an operation state of the user with respect to the motion actuator 60, and a switching state of the HMI devices 70.

The planning unit 20 may include a prediction unit 21, a driving planning unit 22, and a mode management unit 23 as processing units for implementing, by executing a computer program by the processor, sub-functionalities obtained by further classifying the planning functionalities.

The prediction unit 21 acquires external environment information perceived by the environment perception unit 11 and the self-position perception unit 12, the vehicle state perceived by the internal perception unit 13, and the like. The prediction unit 21 may interpret an environment based on the acquired information, and estimate the current situation in which the vehicle 1 is located. The situation here may be an operational situation, or may include an operational situation.

The prediction unit 21 may interpret the environment and predict actions of objects such as other road users. The object here may be a safety-relevant object. The prediction of the action here may include at least one of prediction of a velocity of the object, prediction of an acceleration of the object, and prediction of a trajectory of the object. The prediction of the act may be executed based on a reasonably foreseeable assumption. The prediction unit 21 may estimate an intention of the user, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and user intention estimation information provided by the prediction unit 21, functional constraint information provided by the mode management unit 23, and the like.

The driving planning unit 22 implements a route planning functionality, a behavior planning functionality, and a trajectory planning functionality. The route planning functionality is a functionality of planning at least one of a route to a destination and a lane plan at a middle distance based on the estimation information of the position of the vehicle 1 on the map. The route planning functionality may further include a functionality of determining at least one request of a lane changing request and a deceleration request, based on the lane plan at the middle distance. The route planning functionality may be a mission/route planning functionality in a strategic functionality, or may be a functionality of outputting a mission plan and a route plan.

The behavior planning functionality is a functionality of planning a behavior of the vehicle 1, based on at least one of the route to the destination and the lane plan at the middle distance planned by the route planning functionality, the lane changing request and the deceleration request, the prediction information and the user intention estimation information provided by the prediction unit 21, and the functional constraint information provided by the mode management unit 23. The behavior planning functionality may include a functionality of generating a condition related to a state transition of the vehicle 1. The condition related to the state transition of the vehicle 1 may correspond to a triggering condition. The behavior planning functionality may include a functionality of determining a state transition of an application that implements a DDT, and further include a functionality of determining a state transition of a driving action, based on the condition. The behavior planning functionality may include a functionality of determining a constraint related to a path of the vehicle 1 in a longitudinal direction and a constraint related to the path of the vehicle 1 in a lateral direction, based on information on these state transitions. The behavior planning functionality may be a strategic behavior plan in a DDT functionality, or may output a strategic behavior.

The trajectory planning functionality is a functionality of planning a travel trajectory of the vehicle 1, based on the determination information provided by the prediction unit 21, the constraint related to the path of the vehicle 1 in the longitudinal direction, and the constraint related to the path of the vehicle 1 in the lateral direction. The trajectory planning functionality may include a functionality of generating a path plan. The path plan may include a velocity plan, or the velocity plan may be generated as a plan independent of the path plan. The trajectory planning functionality may include a functionality of generating multiple path plans and selecting an optimal path plan from the multiple path plans, or a functionality of switching between the path plans. The trajectory planning functionality may further include a functionality of generating backup data of the generated path plan. The trajectory planning functionality may be a trajectory planning functionality in the DDT functionality, or may output a trajectory plan.

The mode management unit 23 monitors the driving system 2, and sets a constraint on a functionality related to driving. The mode management unit 23 may manage a mode of automated driving, for example, a state of the automation level. The management of the automation level may include switching between manual driving and automated driving, that is, authority transfer between the user and the driving system 2, that is, management of takeover of driving. The mode management unit 23 may monitor a state of a subsystem related to the driving system 2, and determine a defect of the system (for example, an error, an unstable operation state, a system failure, or a failure). The mode management unit 23 may determine a mode based on the intention of the user, based on the user intention estimation information generated by the internal perception unit 13. The mode management unit 23 may set a constraint on a functionality related to driving, based on at least one of a determination result of the defect of the system, a determination result of the mode, and further, the vehicle state provided by the internal perception unit 13, a sensor abnormality (or sensor failure) signal output from the sensor 40, state transition information of the application and the trajectory plan provided by the driving planning unit 22, and the like.

The mode management unit 23 may have a functionality of determining the constraint related to the path of the vehicle 1 in the longitudinal direction and the constraint related to the path of the vehicle 1 in the lateral direction in an integrated manner, in addition to the constraint on a functionality related to driving. In this case, the driving planning unit 22 plans a behavior and plans a trajectory, in accordance with the constraint determined by the mode management unit 23.

When the risk checking unit 26 is implemented independently of the planning unit 20, a situation extraction unit 27, a situation checking unit 28, a response unit 29, and the like to be described below may be provided separately from the prediction unit 21, the driving planning unit 22, and the mode management unit 23 in FIG. 3. When the risk checking unit 26 is implemented as a part of the planning unit 20, the risk checking functionality of the risk checking unit 26 may be implemented as a part of the functionalities implemented by the prediction unit 21, the driving planning unit 22, and the mode management unit 23.

The acting unit 30 may include a motion control unit 31 and an HMI output unit 71 as processing units for implementing, by executing a computer program by the processor, sub-functionalities obtained by further classifying the action functionalities. The motion control unit 31 controls a motion of the vehicle 1, based on the trajectory plan (for example, the path plan and the velocity plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state, for example, at least one of a current velocity, a current acceleration, and a current yaw rate of the vehicle 1, perceived by the sensing unit 10 (particularly, the internal perception unit 13) from the sensing unit 10, and reflecting the vehicle state on the motion control of the vehicle 1.

The HMI output unit 71 outputs information on an HMI, based on at least one of the prediction information and the user intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction, and control an information presentation functionality of the HMI devices 70. The HMI output unit 71 may generate a control request for a wiper, a sensor cleaning device, a headlight, and an air conditioner based on the management state of the vehicle interaction, and control these devices.

### (Safety Model and Implementation Thereof)

The driving system 2 may implement a safety model of automated driving. The safety model is a model for demonstrating that there is no acceptable risk in a specific operational design domain. The safety model may correspond to, for example, a safety driving model, a safety-related model, or a formal model. As the safety model, for example, the RSS model may be adopted. Meanwhile, another model, a more generalized model, or a complex model obtained by combining multiple models may also be adopted.

For example, in the RSS model, five rules (five principles) are adopted. The first rule is “Do not hit someone from behind”. The second rule is “Do not cut-in recklessly”. The third rule is “Right-of-way is given, not taken”. The fourth rule is, “Be careful of area another one, you must do it”. The fifth rule is “If you can avoid an accident without causing another one, you must do it”.

Based on the five rules, particularly the first and second rules, a safety envelope may be defined. For example, the safety envelope may mean a longitudinal safety distance and a lateral safety distance with respect to other road users or may mean a condition or a concept for calculating these safety distances. The safety distance is an example of a geometric approach.

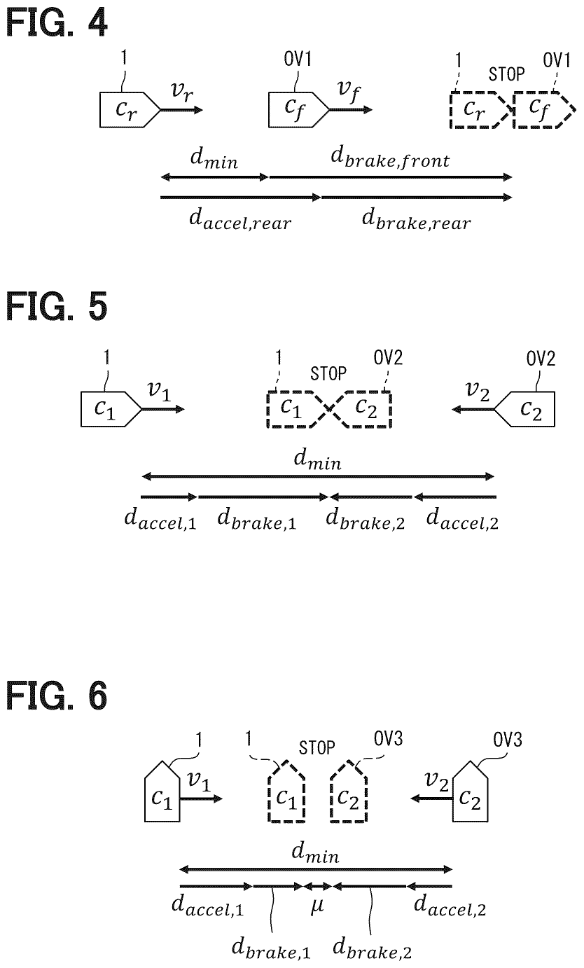

A longitudinal safety distance dₘᵢₙ may be a distance at which a rear-end collision does not occur when a preceding vehicle OV1, traveling at a velocity v_{f}, brakes at a maximum deceleration a_{max, brake} and stops, even when a rear vehicle (for example, vehicle 1) accelerates with a response time p and a maximum acceleration a_{max, accel}, and then brakes at a minimum deceleration amin, brake and stops, as illustrated in FIG. 4.

Here, the stopping distance d_{brake, front} of the preceding vehicle OV1 is expressed by the following expression 1.

$${d}_{brake , front} = \frac{{v}_{f}^{2}}{2 {a}_{max , break}} \qquad [ Formula 1 ]$$

The reaction distance d_{reaction, rear} of the rear vehicle (vehicle 1) is expressed by the following expression 2.

$${d}_{reaction , rear} = {v}_{r} ρ + \frac{1}{2} {a}_{max , accel} {ρ}^{2} \qquad [ Formula 2 ]$$

The braking distance d_{brake, rear} of the rear vehicle (vehicle 1) is expressed by the following Formula 3.

$${d}_{break , rear} = \frac{{( {v}_{r} + {a}_{max , accel} ρ )}^{2}}{2 {a}_{min , brake}} \qquad [ Formula 3 ]$$

The safety distance dₘᵢₙ is expressed by the expression shown in the following Formula 4 as a value obtained by adding the braking distance of the rear vehicle to the reaction distance of the rear vehicle and subtracting the stopping distance of the preceding vehicle OV1.

$${d}_{min} = {d}_{reaction , rear} + {d}_{brakes , rear} - {d}_{brake , front} \qquad [ Formula 4 ]$$

The longitudinal safety distance dₘᵢₙ may be a distance at which a head-on collision does not occur even when two vehicles, the vehicle 1 and a vehicle OV2 are traveling toward each other at their respective velocities v₁ and v₂, accelerate with the predetermined response time p and the maximum acceleration a_{max, accel}, and then brake and stop at the minimum deceleration a_{min, brake}, as illustrated in FIG. 5.

Here, the reaction distance d_{reaction, 1} of the vehicle 1 is expressed by the expression shown in the following Formula 5.

$${d}_{reaction , 1} = {v}_{1} ρ + \frac{1}{2} {a}_{max , accel} {ρ}^{2} \qquad [ Formula 5 ]$$

The braking distance d_{brake, 1} of the vehicle 1 is expressed by the expression shown in the following Formula 6.

$${d}_{brake , 1} = \frac{{( {v}_{1} + {a}_{max , accel} ρ )}^{2}}{2 {a}_{min , brake}} \qquad [ Formula 6 ]$$

The reaction distance d_{reaction, 2} of the vehicle OV2 is expressed by the expression shown in the following Formula 7.

$${d}_{reaction , 2} = {v}_{2} ρ + \frac{1}{2} {a}_{max , accel} {ρ}^{2} \qquad [ Formula 7 ]$$

The braking distance d_{brake, 2} of the vehicle OV2 is expressed by the expression shown in the following Formula 8.

$${d}_{brake , 2} = \frac{{( {v}_{2} + {a}_{max , accel} ρ )}^{2}}{2 {a}_{min , brake}} \qquad [ Formula 8 ]$$

The safety distance dₘᵢₙ is expressed by the expression shown in the following Formula 9 as a sum of the reaction distance of the vehicle 1, the braking distance of the vehicle 1, the reaction distance of the vehicle OV2, and the braking distance of the vehicle OV2.

$${d}_{min} = {d}_{reaction , 1} + {d}_{brake , 1} + {d}_{reaction , 2} + {d}_{brake , 2} \qquad [ Formula 9 ]$$

The lateral safety distance dₘᵢₙ may be a distance at which a minimum distance μ is secured and a collision does not occur even when two vehicles, the vehicle 1 and a vehicle OV3 are traveling side by side at the lateral velocities v₁ and v₂, respectively, accelerate at the predetermined response time ρ and the maximum acceleration a_{max, accel}, and then decelerate in the lateral direction at the maximum deceleration a_{max, brake}, as illustrated in FIG. 6.

Here, the reaction distance d_{reaction, 1} of the vehicle 1 is represented by the expression shown in the following Formula 10.

$${d}_{reaction , 1} = {v}_{1} ρ + \frac{1}{2} {a}_{max , accel} {ρ}^{2} \qquad [ Formula 10 ]$$

The braking distance d_{brake, 1} of the vehicle 1 is expressed by the expression shown in the following Formula 11.

$${d}_{brake , 1} = \frac{{( {v}_{1} + {a}_{max , accel} ρ )}^{2}}{2 {a}_{min , brake}} \qquad [ Formula 11 ]$$

The reaction distance d_{reaction, 2} of the vehicle OV3 is represented by the expression shown in the following Formula 12.

$${d}_{reaction , 2} = {v}_{2} ρ + \frac{1}{2} {a}_{max , accel} {ρ}^{2} \qquad [ Formula 12 ]$$

The braking distance d_{brake, 2} of the vehicle OV3 is represented by the expression shown in the following Formula 13.

$${d}_{brake , 2} = \frac{{( {v}_{2} + {a}_{max , accel} ρ )}^{2}}{2 {a}_{min , brake}} \qquad [ Formula 13 ]$$

The safety distance dₘᵢₙ is expressed by the expression shown in the following Formula 14 as a sum of the reaction distance of the vehicle 1, the braking distance of the vehicle 1, the reaction distance of the vehicle OV3, and the braking distance of the vehicle OV3.

$${d}_{min} = {d}_{reaction , 1} + {d}_{brake , 1} + {d}_{reaction , 2} + {d}_{brake , 2} \qquad [ Formula 14 ]$$

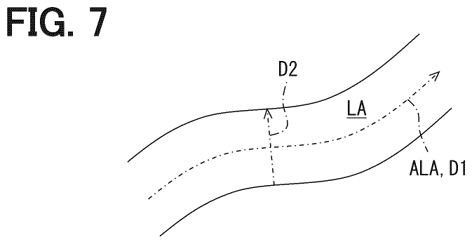

A coordinate system used in the safety model may be a lane-based coordinate system. As illustrated in FIG. 7, this coordinate system processes movement of the vehicle 1 in a direction along a lane LA by defining a center line of the lane LA, that is, a lane axis ALA along a curve of a road. On the other hand, in order to define a longitudinal axis and a lateral axis of each road user, a road-user-based coordinate system may be used. This coordinate system is based on a center of gravity of the road user and defines an ordinate and an abscissa depending on a heading angle of the road user.

For example, as illustrated in FIG. 1, the risk checking unit 26 implemented in the driving system 2 is arranged in parallel with the planning unit 20 and executes a calculation process. Specifically, the risk checking unit 26 acquires an environment model, sensor data, or the like from the sensing unit 10, evaluates a risk based on these pieces of information, and outputs a response according to the risk to the acting unit 30. This series of functionalities or processes may be referred to as risk checking or risk monitoring. The risk checking unit 26 may include the situation extraction unit 27, the situation checking unit 28, and the response unit 29 as sub-blocks obtained by further classifying the functionalities.

The situation extraction unit 27 extracts a situation based on information acquired from the sensing unit 10. Data indicating the situation (hereinafter, situation data) may include a list of objects present in the vicinity of the vehicle 1 (hereinafter, surrounding objects). The surrounding objects may include other road users. The situation data may include data indicative of a potential conflict between the vehicle 1 and the surrounding object. In this case, the situation data may include a probability of the presence, and an uncertainty of a position, an orientation, and a velocity of the vehicle 1 and the surrounding object. The situation extraction unit 27 may extract multiple situations. The situation may be a traffic situation. The situation may be selected from a series of considered situations.

The situation checking unit 28 checks whether the situation extracted by the situation extraction unit 27 is a safe situation or a hazardous situation. The situation checking unit 28 executes at least one of checking by the geometric approach described above and checking by using another methodology. The checking here may be referred to as checking of a risk. When the checking of the risk is executed, a safety envelope may refer to an acceptable collision risk.

The checking of the risk may include checking of an estimated result of the collision risk between the vehicle 1 and the surrounding object. The collision risk may include a collision risk over time, and may include a peak collision risk. The collision risk may be a probability of collision. That is, an uncertainty can be taken into account in the checking of the risk.

When the safety envelope is violated, the situation checking unit 28 determines that a situation as a checking target is a hazardous situation. When the situation checking unit 28 executes checking of the risk, the situation checking unit 28 may compare the estimated collision risk value with a threshold of an acceptable collision risk. When the estimated collision risk value is below the threshold of the acceptable collision risk, the situation checking unit 28 may determine that the situation as a checking target is a safe situation. When the estimated collision risk value exceeds the threshold of the acceptable collision risk, the situation checking unit 28 may determine that the situation as a checking target is a hazardous situation. That is, when there is no violation of the safety envelope, the situation checking unit 28 determines that the situation as a checking target is a safe situation. This risk threshold may be, for example, a longitudinal safety distance and a lateral safety distance.

The situation checking unit 28 may set a hypothesis on the surrounding object, and check a risk based on the hypothesis. In this case, multiple hypotheses may be used. The hypothesis may be or may include an assumption on a reasonably foreseeable behavior. The hypothesis may be a prediction derived based on this assumption, and may include the prediction derived based on this assumption.

That is, there is a possibility that an assumed kinematic value is influenced by an acceptable risk level. The acceptable risk level or risk threshold may be set in advance based on a risk acceptance criteria/criterion. The quantitative criterion of the risk acceptance criteria/criterion is, for example, a probability of occurrence of harm falling below a threshold. The risk acceptance criteria/criterion may be set based on a positive risk balance, which is a main measure of a risk level that is ethically acceptable. The risk acceptance criteria/criterion may be set by, for example, a combination of a statistical approach such as traffic accident statistics and an approach based on a scenario.

The risk acceptance criteria/criterion may be determined based on a comparison between the driving system 2 under a reasonably foreseeable scenario of the ODD and an experienced and attentive driver. For example, the risk acceptance criteria/criterion may be set based on the fact that the capability of the driving system 2 is equal to or higher than the driving ability of an experienced and attentive driver.

The acceptable risk level or the risk threshold may be designated in advance by at least one of, for example, a government agency, a standardization agency, and an approval agency of the driving system 2. The acceptable risk level or the risk threshold may be set in advance by, for example, a developer of the driving system 2.

The driving system 2 or the risk checking unit 26 may be designed to change the risk threshold according to the ODD. The driving system 2 or the risk checking unit 26 may be designed to change the risk threshold according to the use case.

The situation checking unit 28 may refer to a rule set stored in the rule DB 58 to determine the acceptable risk level. The situation checking unit 28 may improve estimation accuracy by incorporating the rules of the rule set into an algorithm for calculating the risk value.

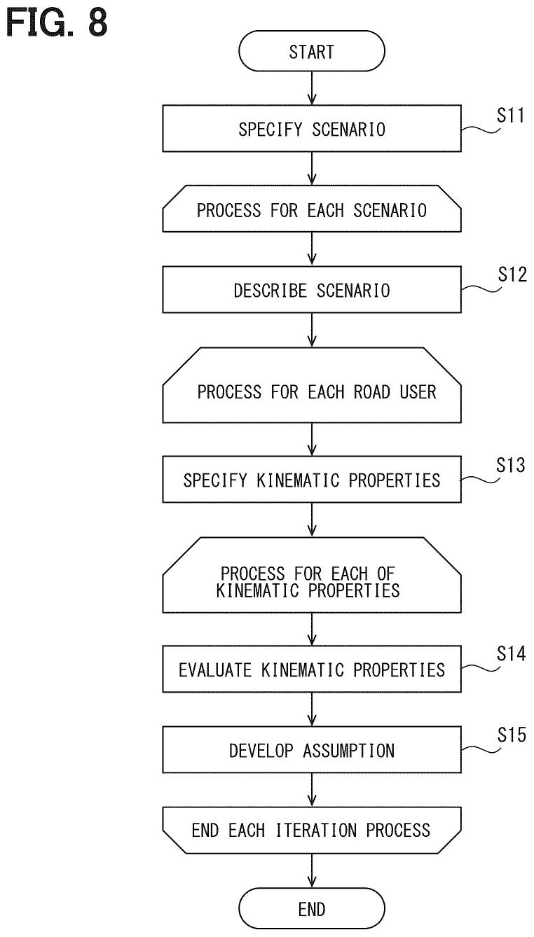

FIG. 8 illustrates an example of a processing method for deriving and defining an assumption. The process may be implemented, for example, by executing a computer program stored in the memory 53a by the processor 53b of the risk checker 53. A series of processes in steps S11 to S15 is executed for each predetermined regular time interval or based on a predetermined trigger. The predetermined trigger may be provided as, for example, the latest situation data being provided from the situation extraction unit 27 to the situation checking unit 28. This process may be used not during actual traveling of the vehicle 1 but in conduction of V&V on the driving system 2 by simulation or the like.

In the first step S11, a scenario currently being encountered by the vehicle 1 is specified. The specifying of the scenario may include selecting a scenario from, for example, a catalog of scenarios stored in the scenario DB 59. One scenario may be selected. Multiple scenarios may be selected. A more complex situation may be represented by combining the multiple scenarios. After the process in S11, the process proceeds to S12.

S12 to S15 are iteration processes for each scenario. In S12, a relevant scene and a road user as dynamic elements are specified and highly described. After the process in S12, the process proceeds to S13.

S14 and S15 are iteration processes for each kinematic property. In S14, whether the kinematic properties are relevant to the safety is evaluated based on the scenario specified in S11. This evaluation is conducted by checking whether a certain property is a motion of other road users and may cause a motion for the vehicle 1. When the kinematic property is not relevant to the safety, the kinematic property is excluded from application to the scenario specified in S11. After the process in S14, the process proceeds to S15.

In S15, an assumption on a reasonably foreseeable behavior of other road users for the scenario specified in S11 is created. The assumption can be defined by setting a boundary for the range of behaviors of other road users that are reasonably foreseeable in a specific travel situation. After the process in S15, the process is returned to S12, S13, and S14 and repeated, depending on the remaining processing state of other scenarios, road users, and kinematic properties. When the process is completed for all the scenarios, the series of processes is ended.

The assumption may be a function of a time which is changed during a specified scenario. Alternatively, the assumption may not be changed during the specified scenario. A minimum set of the assumption on other road users may be defined.

The minimum set may include one or more properties according to a scenario, among a reasonably foreseeable maximum assumed longitudinal velocity other road users could exhibit, a reasonably foreseeable maximum assumed lateral velocity other road users could exhibit, a reasonably foreseeable maximum assumed longitudinal acceleration other road users preceding the vehicle could exhibit, a reasonably foreseeable maximum assumed lateral acceleration other road users could exhibit, a reasonably foreseeable maximum assumed longitudinal deceleration other road users preceding the vehicle could exhibit, a reasonably foreseeable minimum assumed longitudinal deceleration other road users traveling in an opposite direction to the vehicle or following the vehicle could exhibit, a reasonably foreseeable minimum assumed lateral deceleration other road users could exhibit, a reasonably foreseeable maximum assumed heading angle other road users could exhibit, a reasonably foreseeable maximum assumed heading angle rate change other road users could exhibit, a reasonably foreseeable maximum assumed lateral position fluctuation other road users could exhibit, and a reasonably foreseeable maximum assumed response time other road users could exhibit.

The values of these assumptions may differ depending on the category of the road users. For example, an assumption value may be changed depending on whether the road user is a vulnerable road user (VRU). The assumption value may be adjusted depending on at least one of various road surface conditions and weather-related environmental conditions that are reasonably expected within an operational design domain. The assumption value may also be adjusted according to at least one of a difference in road traffic laws across countries and a difference in traffic customs across regions.

The response unit 29 derives a proper response based on the checking result of the situation checking unit 28. The proper response may be provided to the acting unit 30 only when the situation is determined to be a hazardous situation. The proper response may be a restriction of a control command of the motion actuator 60. The proper response may be a response to return the vehicle 1 to a safe state. Even when multiple unrelated hazardous situations are checked, the acts to be taken by the vehicle 1 need to be integrated into one act. Therefore, in this case, the response unit 29 resolves a potential conflict between the proper responses for these situations, and transmits the proper response to the acting unit 30.

The risk checking unit 26 can output at least one of data indicating a situation, a checking result of the situation, and a derived proper response. The risk checking unit 26 may sequentially store at least one of the data indicating the situation, the checking result of the situation, and the derived proper response in the storage medium 55c, by using the recording device 55 or the like. The risk checking unit 26 may transmit at least one of the data indicating the situation, the checking result of the situation, and the derived proper response to an external system (for example, the server 96) using the communication system 43, and store the data indicating the situation, the result of checking the situation, and the derived proper response in a database (for example, the management DB 96c) of the server 96.

The risk checking unit 26 may execute an output in a prioritized manner to maintain duty of care for other road users. The risk checking unit 26 may assist an operation in an emergency. The operation in an emergency may be a DDT fallback. The operation in an emergency may be executed when the proper response to a potentially hazardous situation does not sufficiently reduce the risk when the hazardous situation actually occurs.

The risk checking unit 26 may distinguish between an initiator of a hazardous scenario and a responder of a hazardous scenario. The risk checking unit 26 may distinguish between an action recommended for the initiator and an action recommended for the responder. That is, when the vehicle 1 is the initiator, the risk checking unit 26 derives a proper response according to the action recommended for the initiator, and when the vehicle 1 is the responder, the risk checking unit 26 derives a proper response according to the action recommended for the responder.

### (State Transition and Authority Transfer of Driving System)

The automated driving system at level 3 or 4 in which authority transfer between the system and a human user (for example, a driver) occurs will be described.

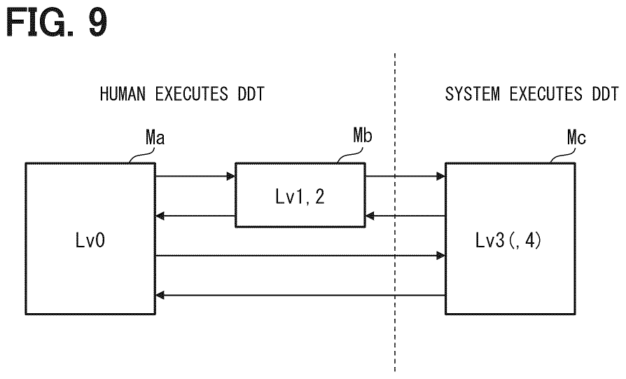

As schematically illustrated in FIG. 9, the mode management unit 23 manages the state transition of the automation level and conducts authority transfer as necessary. When the risk checking unit 26 is provided separately from the mode management unit 23, the mode management unit 23 may manage the automation level with reference to a risk checking result obtained by the risk checking unit 26. When the risk checking unit 26 is provided separately from the mode management unit 23, the risk checking unit 26 may intervene in the management of the automation level of the mode management unit 23. For example, when the risk checking unit 26 detects an unacceptable risk during execution of the DDT by the driving system 2, the risk checking unit 26 may forcibly change the automation level managed by the mode management unit 23 to a lower level.

The transition state of the automation level generally includes three states. The three states are, for example, completely manual driving Ma corresponding to level 0, driving assistance Mb corresponding to levels 1 and 2, and automated driving Mc corresponding to level 3 or 4.

The mode management unit 23 may change, for example, the computer program itself executed in the processes in the planning unit 20 and the acting unit 30 according to the three states. In this aspect, for example, a computer program used in the driving assistance Mb may be prepared separately from a computer program that implements processes in the prediction unit 21 and the driving planning unit 22 used in the automated driving Mc. The mode management unit 23 prohibits the execution of the computer program for the automated driving Mc in the completely manual driving Ma and the driving assistance Mb. The mode management unit 23 performs management such that a computer program for the driving assistance Mb is executed in the driving assistance Mb.

In this case, the implementation of the computer program for driving assistance and the processor that executes the computer program may be implemented by hardware independent of the implementation of the computer program used in the automated driving Mc and the processor that executes the computer program. For example, in the driving system 2, an automated driving ECU and a driving assistance ECU may be provided, and may be selectively used according to the transition state of the automation level. The functionality of the mode management unit 23 may be implemented in the automated driving ECU, or may be implemented in a mode management ECU that is further independent of the automated driving ECU and the driving assistance ECU.

Examples of the computer program for driving assistance include a program of an adaptive cruise control (ACC) application that implements a functionality of following another vehicle while maintaining a lane, a program of an advanced emergency braking (AEB) application that implements a functionality of avoiding a collision with another road user by braking, a program of an advanced emergency steering (AES) application that implements a functionality of avoiding a collision with another road user by steering, and the like.

The mode management unit 23 may constrain or limit the functionalities of, for example, the planning unit 20 and the acting unit 30 according to the three states. In the driving assistance of this aspect, the mode management unit 23 may impose a constraint such that the driving planning unit 22 and the motion control unit 31 do not autonomously control both the driving and braking of the motion actuator 60 and the steering. That is, one of driving, braking, and steering is autonomously controlled by the driving planning unit 22 and the motion control unit 31, and the other is controlled by a driving operation by the user.

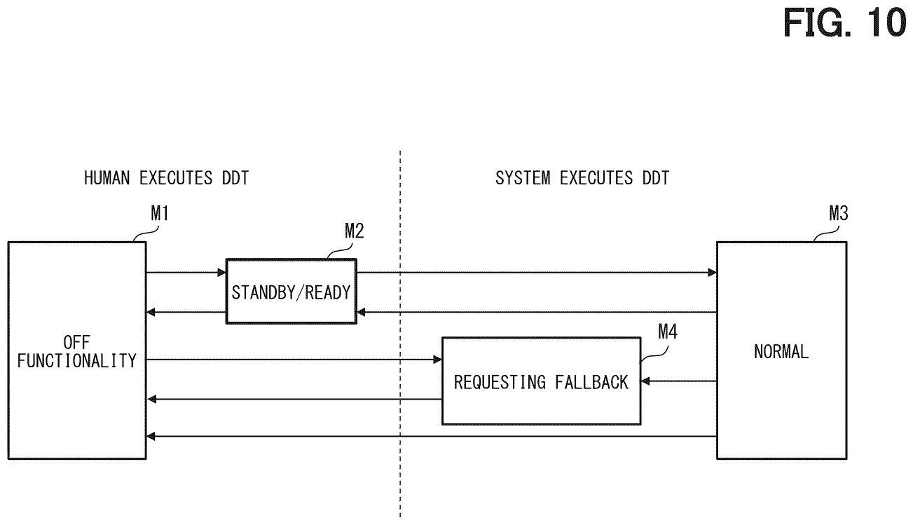

Here, an example of a more detailed state transition in the driving system 2 that implements automated driving at level 3 will be described with reference to FIG. 10. Examples of the transition state of the driving system 2 include four states, an off state M1, a standby/ready state M2, a normal state M3, and a requesting fallback state M4. In the off state M1 and the standby/ready state M2, the user is an execution subject of the DDT, and the user has authority regarding driving. In the normal state M3 and the requesting fallback state M4, the driving system 2 is the execution subject of the DDT, and the driving system 2 has authority regarding driving.

The off state M1 is a state in which the automated driving functionality at level 3 of the driving system 2 is off, and is a state in which any functionality at levels 0 to 2 is exhibited. When the automated driving functionality is turned on in the off state, the driving system 2 transitions from the off state M1 to the standby/ready state M2. The ON operation herein may be an ON operation of an automated driving switch provided in the vehicle 1, which is performed by the user. The ON operation herein may be one of entering the range of the ODD in which the automated driving at level 3 can be executed and approaching the range of the ODD.

The standby/ready state M2 is a state in which any one of the functionalities of levels 0 to 2 is exhibited, and is a state in which standby/ready for shifting to a state in which the automated driving functionality of level 3 is exhibited is started. When the automated driving functionality is turned off in the standby/ready state, the driving system 2 returns from the standby/ready state M2 to the off state M1 again. When the condition is satisfied in the standby/ready state M2, takeover of the driving from the user to the driving system 2 is executed, and the authority is transferred. The driving system 2 transitions from the standby/ready state M2 to the normal state M3.

The normal state M3 is a state in which the functionality of level 3 is exhibited. In the normal state M3, for example, when the user requests (temporary) authority transfer, takeover of driving from the driving system 2 to the user is executed, and the driving system 2 transitions from the normal state M3 to the standby/ready state M2. When the automated driving functionality is turned off in the normal state M3, the takeover of the driving from the driving system 2 to the user is executed, and the driving system 2 transitions from the normal state M3 to the off state together with the authority transfer. The OFF operation herein may be an OFF operation of an automated driving switch provided in the vehicle 1, which is performed by the user.

When the triggering condition is detected in the normal state M3, the driving system 2 transitions from the normal state M3 to the requesting fallback state M4. In the requesting fallback state M4, when the driving system 2 issues a DDT fallback execution request to the user and the user takes over the driving, the driving system 2 transitions from the requesting fallback state M4 to the off state M1 with authority transfer.

When the automated driving functionality is turned off in the requesting fallback state M4, the driving is taken over from the driving system 2 to the user, the authority is transferred, and the driving system 2 transitions from the requesting fallback state M4 to the off state M1.

There are mainly two causes of establishment of the triggering condition for disengaging the automated driving functionality, that is, causes of transition from the normal state to the requesting fallback state. One of the causes is a failure in the vehicle 1 or the driving system 2. The other one thereof is an ODD exit.

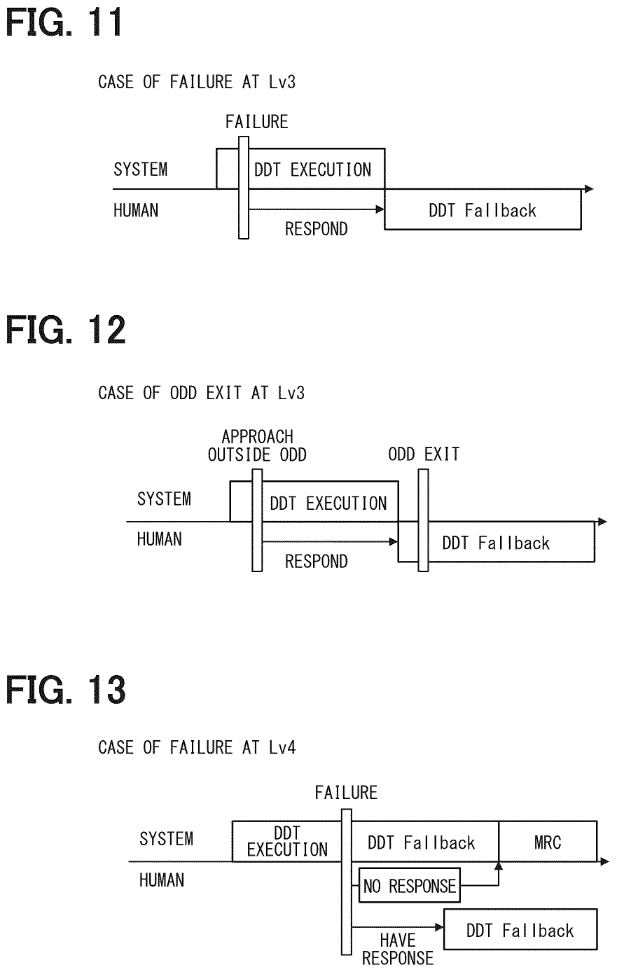

Examples of authority transfer with DDT fallback at level 3 and level 4 will be described with reference to FIGS. 11 to 14.

As illustrated in FIG. 11, a failure in the driving system 2 that makes it difficult to continue automated driving during automated driving at level 3, that is, during execution of DDT by the driving system 2 occurs. Then, the driving system 2 notifies the user of the fallback request through the information presentation device 70b. The user is required to respond to the fallback request for the driving system 2 at level 3. The user takes over driving from the driving system 2 (conducts authority transfer), and starts DDT fallback by manual operation. For example, the user manually evacuates the vehicle 1 to a road shoulder or a side strip of the road.

As illustrated in FIG. 12, during the automated driving at level 3, that is, during the execution of the DDT by the driving system 2, an approach outside the ODD range occurs. Then, the driving system 2 notifies the user of the fallback request through the information presentation device 70b. The user is required to respond to the fallback request. Before exiting the ODD, the user takes over driving from the driving system 2 (performs authority transfer), and starts DDT fallback by manual operation.

As illustrated in FIG. 13, a failure in the driving system 2 that makes it difficult to continue automated driving during automated driving at level 4, that is, during execution of DDT by the driving system 2 occurs. Then, the driving system 2 starts the DDT fallback and notifies the user of the fallback request through the information presentation device 70b. When the user takes over the driving from the driving system 2 within a preset time in response to the fallback request (when authority transfer is conducted), the user then executes the DDT fallback by a manual operation. When the user does not take over the driving from the driving system 2 within a preset time in response to the fallback request (when the authority transfer is not conducted), the driving system 2 continuously performs the DDT fallback and shifts to the MRC.

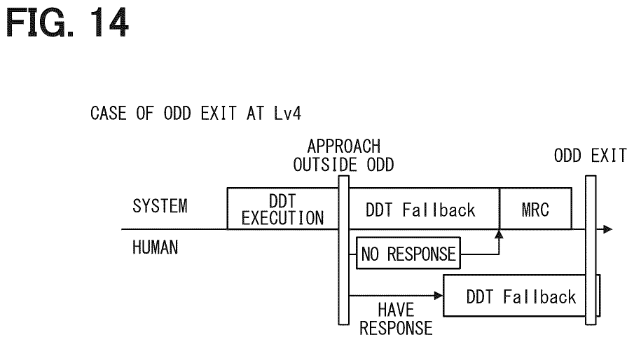

As illustrated in FIG. 14, during the automated driving at level 4, that is, during the execution of the DDT by the driving system 2, an approach outside the ODD range occurs. Then, the driving system 2 starts the DDT fallback and notifies the user of the fallback request through the information presentation device 70b. In response to the fallback request, when the user takes over the driving from the driving system (when the authority transfer is conducted) before the timing at which there is no time to exit the ODD, the user manually performs the DDT fallback. In response to the fallback request, when the user does not take over the driving from the driving system 2 (when the authority transfer is not conducted) before the timing at which there is no time to exit the ODD, the driving system 2 continuously performs the DDT fallback and shifts to the MRC. The shift to the MRC is preferably completed before the ODD exit.

### (V&V Process and Implementation Thereof)

In V&V of the driving system 2, there are verification for satisfying a safety request of each technical level and verification for safe integration of elements. The verification for satisfying the safety request of each technical level may include evaluation of at least one of the following functionalities and capabilities, preferably all of the functionalities and capabilities. The verification may include evaluation of other functionalities and capabilities.

For example, an evaluation target for the sensing unit 10 is a functionality of the sensor 40 or an external data source (for example, a map data source), a functionality of a sensor algorithm that models an environment, and reliability of the infrastructure and the communication system 43.

For example, the evaluation target related to the planning unit 20 is the capability of the determination algorithm. The capability of the determination algorithm is, for example, a capability of safely handling a potential lack of functionality, and a capability of making a proper determination according to an environment model, a driving policy, a current destination, and the like. For example, the evaluation targets related to the planning unit 20 include one of the absence of unreasonable risks due to hazardous behaviors of the intended functionality, the functionality of the system to safely handle ODD use cases, a robust performance of execution of the entire ODD driving policy, suitability for DDT fallback, and suitability for minimal risk conditions.

For example, the evaluation target may include robust performance of a system or a functionality. The robust performance of the system or the functionality is a robust performance of a system under adverse environmental conditions, suitability of a system operation under known triggering conditions, sensitivity of an intended functionality, an ability to monitor various scenarios, or the like.

In order to manage an unacceptable risk and improve the driving system 2, it is preferable that there is a strong management system MS for the driving system 2 after shipment to the market. For example, a management system MS illustrated in FIG. 10 changes the software for a vehicle population by over-the-air (OTA). The management system MS includes the vehicle population including multiple vehicles TTA and TTB, and the server 96. The vehicles TTA and TTB managed by the management system MS may have the same configuration as the vehicle 1 including the driving system 2 described above, and some of the hardware specifications such as the vehicle type and the vehicle model may be different from each other as long as there is compatibility in the software specifications at least.

In the test in the change process, an index related to safety is used. The result of the validation using the index related to safety may not be used only to determine whether the test software is applicable. For example, the result may be used to set the ODD itself or to set parameter restrictions by the ODD.

### (Configuration Example of Server)

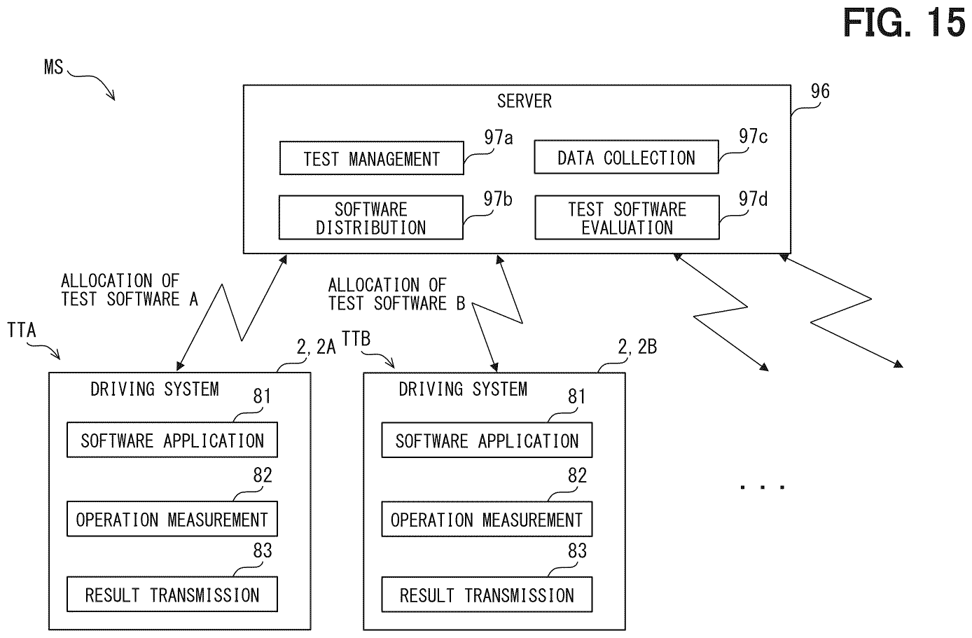

As shown in FIG. 15, the server 96 is installed in an external environment for the vehicles TTA and TTB. The server 96 is communicably connected to the vehicles TTA and TTB by, for example, V2X communication via a communication infrastructure. The management system MS executes a software test for improvement in safety. That is, the management system MS may be an improvement system that improves the performance or safety of the driving systems 2A and 2B.

As illustrated in FIG. 2, the server 96 may be mainly implemented by a dedicated computer including at least one memory 96a and at least one processor 96b. The memory 96a may be, for example, at least one type of non-transitory tangible storage medium, such as a semiconductor memory, a magnetic medium, and an optical medium, which non-temporarily stores a computer program, data, and the like that can be read by the processor 96b. For example, a rewritable volatile storage medium such as a random access memory (RAM) may be provided as the memory 96a. The processor 96b includes, for example, at least one type of a central processing unit (CPU), a graphics processing unit (GPU), and a reduced instruction set computer (RISC)-CPU as a core.

The dedicated computer may be a system on a chip (SoC) in which the memory 96a, the processor 96b, and an interface are integrally implemented on one chip, or at least one SoC may be provided as an element of the dedicated computer.

The server 96 may further include a management database (hereinafter, the management DB) 96c. The management DB 96c may store information for specifying the vehicles TTA and TTB to be managed by the management system MS. The management DB 96c may store information on specifications of the vehicles TTA and TTB. The management DB 96c may store various types of information collected from the vehicles TTA and TTB. The various types of information may include information for executing an evaluation in a test for improving safety to be described below.

The server 96 implements a safety improvement functionality for improving the safety. As illustrated in FIG. 10, the server 96 may include a test management unit 97a, a software distribution unit 97b, a data collection unit 97c, and a test software evaluation unit 97d as processing units for implementing the safety improvement functionality by the processor 96b executing a computer program.

The test management unit 97a manages a test executed for safety improvement. The test may be a test for determining the best software among multiple pieces of test software. When two types of test software are prepared and the two types of test software are compared with each other, this test is referred to as an AB test. The multiple pieces of test software may be three or more types of software that have similar functionalities and can be compared with one another.

The test software is provided by, for example, a human administrator (hereinafter, a test administrator) of the server 96. In this case, the test is conducted for the purpose of selecting the optimum software from the software as a release candidate. On the other hand, when the test is conducted to optimize the parameters used for the computer program, the test software may be software automatically generated by the test management unit 97a in a form of changing the parameters of the existing program.

The test management unit 97a manages the scale of the test and the period of the test. The scale and the period may be set to values input to the server 96 by the test administrator, or may be automatically set by the test management unit 97a. The test management unit 97a determines a test target vehicle suitable for conducting the test from the vehicles TTA and TTB belonging to the vehicle population based on the scale and the period. When the number of vehicles incorporated in the management system MS is smaller than the optimum scale for conducting the test, all the vehicles TTA and TTB belonging to the vehicle population may be designated as the test target vehicles.

The test management unit 97a allocates one of the multiple pieces of test software to the test target vehicle among the vehicles TTA and TTB belonging to the vehicle population. For example, in a test for comparing test software A and test software B, half of the test target vehicles test the test software A, and the remaining half of the vehicles test the test software B. The test management unit 97a may randomly allocate the test software to the vehicles TTA and TTB using a pseudo-random number. The test management unit 97a may refer to vehicle information stored in the management DB 96c and execute the allocation of the test software so as to reduce the bias of the condition between the groups for testing the test software.

The test management unit 97a sets at least one evaluation index for evaluating the test software. The evaluation index may be set, based on the functionalities and properties of the test software or the intention of the test, to an index determined by the input operation of the test administrator to the server 96. Alternatively, the evaluation index may be set by the test management unit 97a based on the functionalities and properties of the test software.

The evaluation index includes an index related to safety. The index related to safety may be a value obtained by indexing the risk checked by the risk checking unit 26. The value obtained by indexing the risk includes, for example, the risk value, the safety envelope, the safety distance, and the violation metric (violation degree). The violation metric (violation degree) is a value obtained by evaluating the degree of violation of the vehicle 1 (test target vehicle) with respect to the rule stored in the rule set.

The index related to safety may be a safety metric of the automated driving system. The safety metric may mean a scale that can be quantified based on a collision rate. Examples of the safety metric include the severity and frequency of collision, the severity and frequency of citable offences, the distances in the longitudinal direction and the lateral direction, the accelerations in the longitudinal direction and the lateral direction, the jerk in the longitudinal direction and the lateral direction, the OEDR response time, and the like. The severity of the collision may be evaluated in six stages using, for example, abbreviated injury scale (AIS). The distances in the longitudinal direction and the lateral direction are indexes related to maintenance of a safety envelope or a safety distance.

The index related to safety may be a human evaluation related to safety. The human herein may be a user of the test target vehicle. In this case, the evaluation related to safety is an evaluation input by the user through the operation input device 70a of the test target vehicle. The human herein may be another VRU such as a pedestrian who encounters the test target vehicle. In this case, the evaluation related to safety may be an evaluation transmitted to the driving systems 2A and 2B or the server 96 by another VRU who feels that the test target vehicle is hazardous using the mobile terminal 91 or the like owned by the VRU.

The test management unit 97a may manage a method for acquiring consent from a human side for applying test software in each test target vehicle. The consent will be described in detail below. The test management unit 97a may store the consent acquisition method in each of the driving systems 2A and 2B of the test target vehicles.

The software distribution unit 97b distributes the test software to the driving system 2 of the test target vehicle based on the allocation of the test software set by the test management unit 97a. Information on a plan of the test may be distributed together with the distribution of the test software. The information on the plan of the test includes information on a period and an evaluation index of the test, and may further include information such as a scale of the test. Accordingly, the test software distributed by each of the driving systems 2A and 2B is temporarily applied, and the test is started.

The data collection unit 97c collects information on an operation of the test software or an operation result thereof as probe data from each of the driving systems 2A and 2B to which the test software is temporarily applied. The information to be collected includes at least one of an index itself related to safety and information for deriving the index related to safety. The data collection unit 97c accumulates the data sequentially collected from the vehicles TTA and TTB in the management DB 96c.

The test software evaluation unit 97d compares multiple pieces of test software. The test software evaluation unit 97d compares an evaluation index set by the test management unit 97a between pieces of test software. When there are multiple evaluation indexes, the test software evaluation unit 97d compares each of evaluation indexes between pieces of test software.

Specifically, the test software evaluation unit 97d statistically processes the data from the vehicles TTA and TTB accumulated in the management DB 96c. For example, when the evaluation index can be expressed by a ratio such as an occurrence rate, the test software evaluation unit 97d calculates an occurrence rate per vehicle and/or per unit time from the occurrence frequency in the data from the vehicles TTA and TTB.

In the evaluation using the safety metric as the evaluation index, it is preferable to consider severity potential. In the case of evaluating the severity and frequency of a collision for the test software, even if the test software is temporarily applied to multiple vehicles TTA and TTB, it is difficult to statistically evaluate the severity and frequency of a collision when there are few cases in which a collision actually occurs. Therefore, the test software evaluation unit 97d may estimate a rate of serious collisions having a high severity from the occurrence rate of proper precursor events such as a near collision and a collision with a low severity.

The distribution and sensitivity of the collision type may be different between an automated driving system and a human driver. Therefore, in the statistical evaluation of the safety metric for the test software, the evaluation may be performed after the vehicles to which the test software is applied are classified into an automated driving vehicle of level 3 or higher and a vehicle driven by a human user.

The test software evaluation unit 97d may have a functionality of selecting one piece of optimum test software from multiple pieces of test software. The optimum test software may be test software with the highest safety. The test management unit 97a may determine the test software selected by the test software evaluation unit 97d as formal software to be formally adopted. Based on this determination, the software distribution unit 97b may distribute the formal software to the vehicles TTA and TTB belonging to the vehicle population. The distribution destination vehicle may include a vehicle that belongs to the vehicle population and is not the test target vehicle.

When the multiple pieces of test software are an improvement plan of a currently applied software that is formally applied to each of the vehicles TTA and TTB, the test software evaluation unit 97d may execute a relative evaluation of the selected test software with respect to the currently applied software. The test software evaluation unit 97d may determine that the selected test software does not have higher performance than the currently applied software. In this case, the test management unit 97a may exclude all of the multiple pieces of test software from formal software to be formally adopted.

On the other hand, the test software evaluation unit 97d may not have a functionality of selecting the optimum test software. In this case, the test management unit 97a presents a comparison result of an evaluation index to the test administrator through the HMI, and receives an input operation of the selection result of the formal software to be formally adopted by the test administrator. In accordance with this input operation, the test management unit 97a determines the formal software. Based on this determination, the software distribution unit 97b may distribute the formal software to the vehicles TTA and TTB belonging to the vehicle population.

### (Configuration Example of Driving System)

Driving systems 2A and 2B are implemented in each of the vehicles TTA and TTB belonging to the vehicle population. The driving systems 2A and 2B implement a safety-improving functionality in addition to the perception functionality, the planning functionality, and the acting functionality described above. The safety-improving functionality is a functionality of improving the safety of the driving systems 2A and 2B. The driving systems 2A and 2B may each include a software application unit 81, an operation measurement unit 82, and a result transmission unit 83 as processing units for implementing a safety-improving functionality by the processor 51b executing a computer program.

The software application unit 81 manages application of software implemented in the driving systems 2A and 2B. The application of the software herein may include download and installation of the software, that is, standby/ready for making the software usable. The management of the application of the software may include defense against external attacks that exploit security vulnerabilities and management of software updates. When the formal software is distributed, the software application unit 81 permanently applies the formal software to the driving systems 2A and 2B. The permanent application herein means application until the next update of the formal software.

The management of the application of software may include management of the application of test software. When the vehicles TTA and TTB are selected as the test target vehicles, the software application unit 81 temporarily applies the test software distributed from the server 96 to the driving systems 2A and 2B, and starts verification of the test software.

The management of the application of the test software may include the management of consent of a human user to the application of the test software. The consent can be rephrased as acceptance, permission, contract, or the like. The consent to applying the test software may include consent to actually testing the test software (hereinafter, test consent). The software application unit 81 requests the consent of the user based on an acquisition method of a test consent designated in advance by the server 96 or an acquisition method of the test consent set by itself.

When the test consent of the user is acquired, the software application unit 81 records the acquisition information of the test consent in the storage medium 55c and permits the execution of the test software. The software application unit 81 prohibits execution of the test software when the test consent of the user has not been acquired.

The software application unit 81 may stop or end the application of the test software to the driving systems 2A and 2B after starting the test. For example, when the test period is completed, the application of the test software is ended. For example, even during the test period, when the formal software to be formally adopted is determined, the application of the test software is ended. For example, when the test itself is stopped due to a serious problem of the test software, the application of the test software is stopped.

The operation measurement unit 82 measures an operation result of the temporarily applied test software. The measurement target is at least one of an evaluation index designated from the server 96 side and data necessary for calculation of the evaluation index. As described above, the evaluation index includes an index related to safety. The measurement of the operation result may be constantly conducted according to the properties of the evaluation index, or may be conducted only in a predetermined case based on a preset trigger.

The result transmission unit 83 transmits results of a test to the server 96. The results of the test may be sequentially transmitted in the progress of the test, or may be collectively transmitted at the end of the test period. The results of the test include at least one of test software application information to the driving systems 2A and 2B by the software application unit 81 and measurement information measured by the operation measurement unit 82. The test software application information may include a date and time and a period when the test software is applied to the driving systems 2A and 2B, a method of applying the test software to the driving systems 2A and 2B, and the like. The measurement information is information on the measurement target described above.

One of the operation measurement unit 82 and the result transmission unit 83 may record the results of the test in the storage medium 55c. A transmission log to the server 96 may be recorded in the storage medium 55c together with the results of the test.

As described above, the operation measurement unit 82 selects an index or data to be measured and an acquisition source from which the index or data is acquired, that is, a measurement target, based on the information of the evaluation index received from the server 96. Then, the operation measurement unit 82 generates the measured index or data in the form of measurement information according to a preset format. This format may be designated from the server 96 in the information of the evaluation index. The generated measurement information can be transmitted to the server 96 as probe data and recorded in the storage medium 55c as described above.

### (Flow of Test)

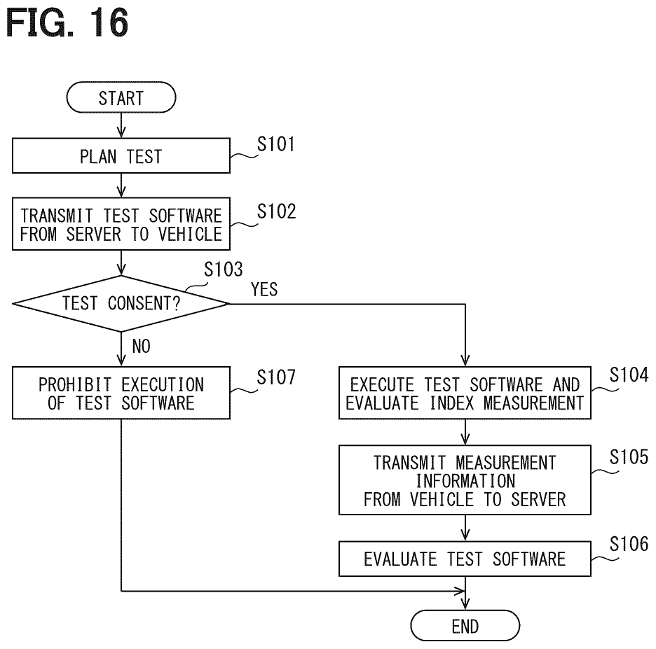

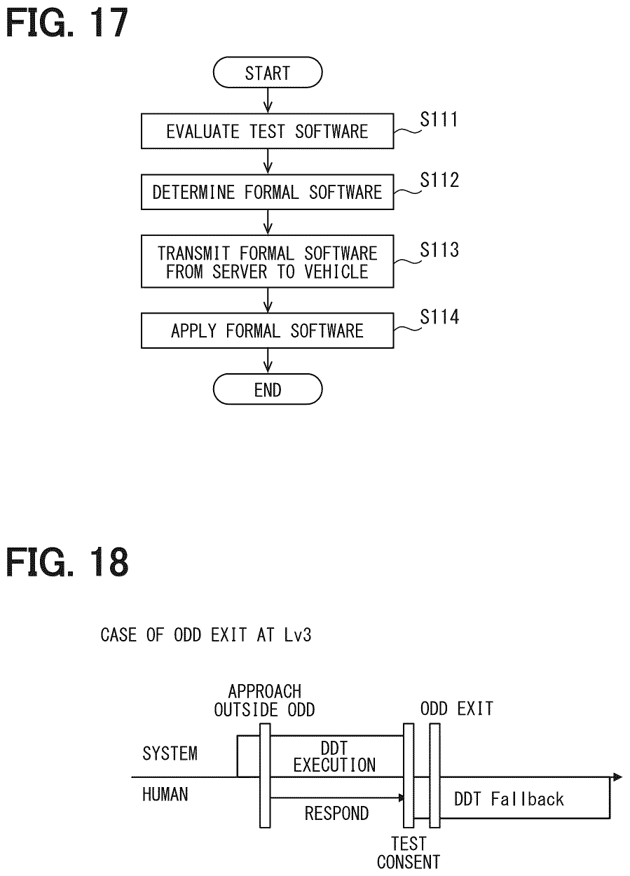

Here, an example of a test conducting method for improving safety will be described with reference to a flowchart in FIGS. 16 and 17. The series of processes may be implemented, for example, by the processor 96b of the server 96 executing a computer program stored in the memory 96a and the processor 51b of the processing system 50 executing a computer program stored in the memory 53a. A trigger for starting the process and a trigger for advancing each step may be given by an input operation of the test administrator to a user interface in the server 96.

The flowchart in FIG. 16 illustrates a process from planning of a test to an evaluation of test software. In the first S101, a test is planned in the server 96. The test planning includes at least one, preferably all, of the determination of the scale of the test and the test period described above, the determination of the test target vehicle, the allocation of the test software, an evaluation method of the test software, and a method for acquiring the test consent. After the process in S101, the process proceeds to S102.

In S102, the server 96 transmits the test software to each test target vehicle based on the allocation of the test software in the test target vehicle. In response, the driving system plans to perform the test. After the process in S102, the process proceeds to S103.

In S103, the driving systems 2A and 2B attempt to acquire the consent of the user based on a method of acquiring the test consent designated from the server 96 and a method of acquiring the test consent preset by the driving systems 2A and 2B. That is, consent is requested. Next, the driving systems 2A and 2B sense the operation of the user on the operation input device 70a or the like, and determine whether the test consent has been acquired. In the case of Yes, the process proceeds to S104. In the case of No, the process proceeds to S107.

In S104, in each of the driving systems 2A and 2B, the test software is executed, and the operation of the test software is measured. That is, the evaluation index or data necessary for calculation of the evaluation index designated from the server 96 is measured. After the process in S104, the process proceeds to S105.

In S105, each of the driving systems 2A and 2B transmits the measurement information measured in S104 to the server 96. In this way, the server 96 collects the measurement information from each test target vehicle in a form that enables a statistical process. After the process in S105, the process proceeds to S106.

In S106, the test software is evaluated in the server 96. That is, the evaluation index is compared for each test software. The series of processes is finished after S106.

On the other hand, in S107 when the test consent cannot be acquired, the driving systems 2A and 2B prohibit the execution of the test software. The series of processes is finished after S107. When the test consent is not obtained, the driving systems 2A and 2B may attempt to acquire the consent again. In this case, the driving systems 2A and 2B may change the method of acquiring the test consent. For example, when the consent operation is an operation unsuitable for the user, the possibility of obtaining the consent of the user can be increased by changing the acquisition method. On the other hand, the driving systems 2A and 2B may maintain the same method as the test consent acquisition method. When it is determined that the user does not consent intentionally (that is, the consent is rejected), the driving systems 2A and 2B may stop acquiring the consent again.

The flowchart in FIG. 17 illustrates a process when the formal software is determined based on the evaluation result of the test software. The process in S111 corresponds to the processes in S101 to S107 in FIG. 16. After the process in S111, the process proceeds to S112.

In S112, on the server 96 side, the formal software to be formally adopted is determined based on the evaluation result of the test. After the process in S112, the process proceeds to S113.

In S113, formal software is transmitted from the server 96 to each of the vehicles TTA and TTB. After the process in S113, the process proceeds to S114.

In S114, formal software is applied to each of the vehicles TTA and TTB. The series of processes is ended after S114. The test and the evaluation of the test software may not be used to determine whether the formal software can be adopted. For example, the test and the evaluation of the test software may be conducted for academic research on the safety of automated driving.

### (Method for Acquiring Test Consent)

A method for acquiring test consent designated by any of the server 96 and the driving systems 2A and 2B will be described.

The acquisition timing of the test consent is a timing corresponding to the functionality and property of the test software, and is set to be in conjunction with the timing of the state transition. It is assumed that the test is a test of a functionality related to execution of the DDT by the user, for example, a test of a functionality related to driving assistance corresponding to levels 1 and 2 illustrated in FIG. 9. In this case, the timing at which the transition state transitions from the completely manual driving Ma corresponding to level 0 to the driving assistance Mb or the timing at which the transition state transitions from the automated driving Mc corresponding to level 3 or 4 to the driving assistance Mb is set as the acquisition timing of the test consent.

Examples of the test of the functionality related to the execution of the DDT by the user include a test of an ACC application, a test of an AEB application, and a test of an AES application. These applications assist the execution of the DTT by the user in a state in which the user is responsible for the execution of the DDT.

It is assumed that the test is a test of a functionality related to the DDT by the driving system 2, for example, a test of a functionality related to automated driving corresponding to level 3 or 4 illustrated in FIG. 9. In this case, the timing at which the transition state transitions from the completely manual driving Ma to the automated driving Mc or the timing at which the transition state transitions from the driving assistance Mb to the automated driving Mc is set as the acquisition timing of the test consent.

The test of the functionality related to the DDT by the driving systems 2A and 2B herein is, for example, a test of a prediction functionality of an action of another road user or the like used by the prediction unit 21, a test of various planning functionalities used by the driving planning unit 22, or a test of a risk checking functionality used by the risk checking unit 26. The test of the planning functionality is, for example, a test related to a threshold for whether to execute the lane change in the normal state, or a test of the planning functionality until the transition to the minimal risk condition in the execution of the DDT fallback by the driving systems 2A and 2B.

Among the above, the timing of transition from the automated driving Mc corresponding to level 3 or 4 to the driving assistance Mb, the timing of transition of the transition state from the completely manual driving Ma to the automated driving Mc, and the timing of transition from the driving assistance Mb to the automated driving Mc can be said to be in conjunction with the timing of authority transfer. In the state transition illustrated in FIG. 10, when the state transitions from the off state M1 to the normal state M3 via the standby/ready state M2, that is, when the standby/ready state M2 has a short time so that the user cannot sufficiently perceive the presence of the standby/ready state M2, even if there is a request for consent at the timing from the off state M1 to the standby/ready state M2, it can be said that the timing is in conjunction with the timing of the authority transfer.

The acquisition timing in conjunction with the timing of the state transition herein may be the only timing for consent. On the other hand, the acquisition timing in conjunction with the timing of the state transition may be the final timing for consent. For example, the user may indicate an intention of consent in advance by operating a dedicated consent switch or the like provided in the operation input device 70a for a test of a functionality related to the DDT by the driving systems 2A and 2B. The dedicated consent switch may be a mechanical switch provided on a spoke or the like of the steering wheel, or may be an image switch displayed on a touch-operable screen of the information presentation device 70b or the like that also functions as the operation input device 70a. When the prior consent is not obtained, the software application unit 81 may request the consent of the user at the acquisition timing in conjunction with the timing of the state transition, which is the final timing.

The consent at the acquisition timing in conjunction with the timing of the state transition may be acquired by causing the user to operate a dedicated consent switch or the like provided in the operation input device 70a, similarly to the prior consent.

The consent at the acquisition timing in conjunction with the timing of the state transition may be acquired by an operation common to the operation related to the state transition. For example, when consent is requested in conjunction with the timing of authority transfer from the driving systems 2A and 2B to the user, contact with the operation input device 70a for controlling the motion actuator 60 when the user starts the DDT may be detected, and the contact may be regarded as the acquisition of consent.

The contact with the operation input device 70a for controlling the motion actuator 60 may be, for example, gripping a steering wheel by a user or stepping on a brake pedal or an accelerator pedal by a user. In such a method for acquiring the test consent, it is preferable that the software application unit 81 presents, together with the request to the user, that the contact with the operation input device 70a for controlling the motion actuator 60 is regarded as the acquisition of the test consent through the information presentation device 70b or the like.

When the first test consent is acquired in conjunction with the timing of authority transfer from the driving systems 2A and 2B to the user, that is, when the same test software is continuously tested, the same consent acquisition as the first time may be conducted at the next and subsequent timings of the authority transfer from the driving systems 2A and 2B to the user. When the first test consent is acquired in conjunction with the timing of authority transfer from the user to the driving systems 2A and 2B, that is, when the same test software is continuously tested, the same consent as the first consent may be acquired at the next and subsequent timings of the authority transfer from the user to the driving systems 2A and 2B.

On the other hand, when the test consent is acquired in conjunction with the authority transfer timing, that is, when the same test software is continuously tested, the next and subsequent authority transfer timings are considered. At this time, the software application unit 81 may determine that the validity of the consent is continued, and notify, through the information presentation device 70b, the user of the fact that the test consent has already been made. Alternatively, at this time, the software application unit 81 may determine that the validity of the consent is continued, and may not acquire the consent and give the notification of the consent. As described above, the software application unit 81 regulates the consent acquisition a plurality of times and regulates the notification a plurality of times, so that the user can be prevented from feeling inconvenience.

An example of the acquisition of test consent when authority is transferred from the driving systems 2A and 2B to the user in response to an ODD exit will be described. As illustrated in FIG. 18, during the automated driving at level 3, that is, during the execution of the DDT by the driving systems 2A and 2B, an approach outside the ODD range occurs. Then, the driving systems 2A and 2B notify the user of the fallback request through the information presentation device 70b. The user is required to respond to the fallback request. Before exiting the ODD, the user takes over driving from the driving systems 2A and 2B (conducts authority transfer), and starts the DDT fallback by the manual operation.

The notification of the test consent request to the user and the fallback request may be made through the information presentation device 70b. The test consent may be regarded as being acquired by contact with the operation input device 70a for controlling the motion actuator 60 when the user starts the DDT fallback.

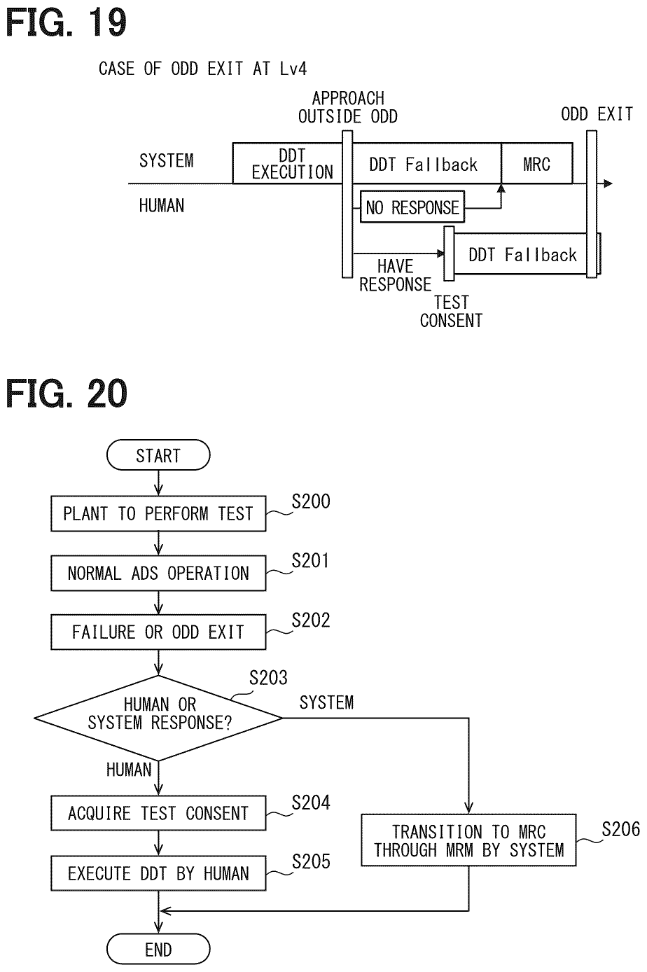

As illustrated in FIG. 19, during automated driving at level 4, that is, during the execution of the DDT by the driving systems 2A and 2B, a failure in the driving systems 2A and 2B that makes it difficult to continue the automated driving occurs. Then, the driving systems 2A and 2B start the DDT fallback and notify the user of the fallback request through the information presentation device 70b. When the user takes over the driving from the driving systems 2A and 2B within a preset time in response to the fallback request (when authority transfer is conducted), the user then executes the DDT fallback by a manual operation. When the user does not take over the driving from the driving systems 2A and 2B within a preset time in response to the fallback request (when the authority transfer is not conducted), the driving systems 2A and 2B continuously execute the DDT fallback and transition to the MRC.

The notification of the test consent request to the user and the fallback request may be made through the information presentation device 70b. The test consent may be regarded as being acquired by contact with the operation input device 70a for controlling the motion actuator 60 when the user starts the DDT fallback in response to the fallback request.

In the method for acquiring test consent as illustrated in FIGS. 18 and 19, test software can be applied to any functionality used after authority transfer to a user, and a test can be executed. For example, test software can be applied to an assistance functionality that assists execution of the DDT fallback in the manual operation by a user, and a test can be conducted.

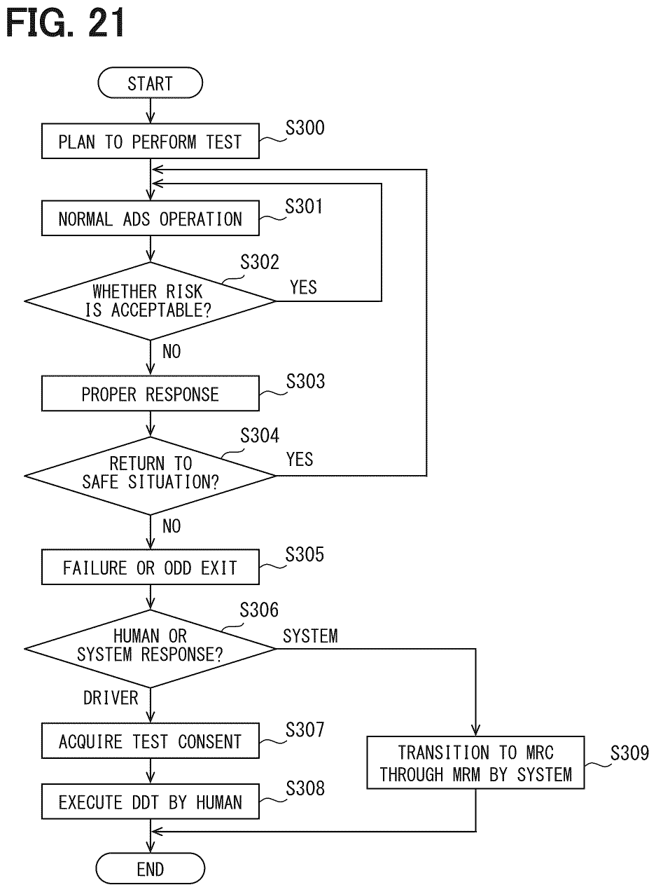

FIGS. 20 and 21 are flowcharts illustrating an example of a method for acquiring test consent. A series of processes in FIGS. 20 and 21 may be implemented by the processor 51b of the processing system 50 executing a computer program stored in the memory 53a. The flowchart in FIG. 20 illustrates a process when the risk checking unit 26 does not intervene in the acting unit 30 or the like before the DDT fallback is executed.

In the first S201 in FIG. 20, the planning unit 20 (particularly, the driving planning unit 22 and the mode management unit 23) executes a system operation in the normal state.

After S201, when the driving systems 2A and 2B are in a state in which a failure or exit from the ODD has occurred or is likely to occur, the sensing unit 10 (particularly, the environment perception unit 11 and the internal perception unit 13) senses the failure or exit (S202). After the process in S202, the process proceeds to S203.

In S203, the mode management unit 23 issues a fallback request and a test consent request to the user. The mode management unit 23 determines whether there is a user response perceived by the internal perception unit 13. When the user is responding, the process proceeds to S204. When the user does not respond, the process proceeds to S206.

In S204, it is considered that the software application unit 81 can acquire the consent of the test by the response of the user, particularly, the contact with the operation input device 70a for controlling the motion actuator 60. After the process in S204, the process proceeds to S205.

In S205, a DDT (for example, a DDT fallback) is executed by a manual operation of the user. The series of processes is ended after S205.

In S206 when the user does not respond, the DDT fallback is executed by the driving systems 2A and 2B. That is, the driving planning unit 22 and the motion control unit 31 execute the shift to the MRC through a minimal risk maneuver (MRM). The series of processes is ended after S206.

The flowchart in FIG. 21 illustrates a process when the risk checking unit 26 intervenes in the acting unit 30 and the like before the DDT fallback is executed. In the first S301 in FIG. 21, the planning unit 20 (particularly, the driving planning unit 22 and the mode management unit 23) executes a system operation in the normal state. After S301, the process proceeds to S302.

In S302, the risk checking unit 26 determines whether the risk is acceptable. In the case of Yes, the process returns to S301. In the case of No, the process proceeds to S303. Note that the process in S302 may be executed in parallel with S301 (by separate processors).

In S303, the risk checking unit 26 outputs a proper response for returning the vehicle 1 to the safe state to the acting unit 30. After the process in S303, the process proceeds to S304.

In S304, the risk checking unit 26 or the driving planning unit 22 determines whether the vehicle 1 has returned to a safe situation. In the case of Yes, the process returns to S301.

In the case of No, when a failure or the exit from the ODD has occurred or is likely to occur in the driving systems 2A and 2B, the sensing unit 10 (particularly, the environment perception unit 11 and the internal perception unit 13) senses the failure or exit (S305). After the process in S305, the process proceeds to S306. The processes in S306 to S309 are the same as the processes in S203 to S206.

According to the first embodiment described above, the consent of the user to the execution of the test of the test software is requested in conjunction with the timing of the authority transfer. That is, the consent to the test software to be used after the authority transfer between the driving systems 2, 2A, and 2B and the user can be acquired together with the authority transfer. Therefore, the validity of conducting the test can be ensured while reducing the inconvenience felt by the user for acquiring the consent. Therefore, it is possible to provide the driving systems 2, 2A and 2B suitable for performance improvement and the test method thereof.

According to the first embodiment, the test is a test of a functionality related to execution of the DDT by the user. In this case, in requesting the consent of the user, the consent is requested in conjunction with the timing of the authority transfer from the driving systems 2, 2A and 2B to the user. In this way, when the user starts executing the DDT, that is, when there is a possibility that the test software operates, consent is requested, and thus the inconvenience felt by the user can be further reduced.

In addition, the driving systems 2, 2A, and 2B are configured such that, in requesting the consent of the user, it is considered that the consent has been acquired by contact with the operation input device 70a for controlling the motion actuator 60 that causes the vehicle 1 to move when the user starts the DDT. In this way, it is less necessary for the user to perform a special operation in order to consent the performance of the test, and therefore, both the acquisition of consent and the authority transfer can be smoothly performed.

According to the first embodiment, the timing of the authority transfer from the driving systems 2, 2A, and 2B to the user occurs with the exit from the ODD set in advance in the driving systems 2, 2A, and 2B. In this case, the driving systems 2, 2A, and 2B are configured such that, in requesting the consent of the user, it is considered that the consent has been acquired by contact with the operation input device 70a for controlling the motion actuator 60 that causes the vehicle 1 to move when the user starts the DDT fallback. In this way, it is less necessary for the user to perform a special operation in order to consent the performance of the test, and therefore, both the acquisition of consent and the authority transfer can be smoothly performed.

According to the first embodiment, the test is a test of a functionality related to the DDT by the driving systems 2, 2A, and 2B. In this case, in requesting the consent of the user, the consent is requested in conjunction with the timing of the authority transfer from the user to the driving systems 2, 2A, and 2B. In this way, consent is requested when the driving systems 2,2 A and 2B start execution of the DDT, that is, when there is a possibility that the test software operates, and therefore, the inconvenience felt by the user can be further reduced.

According to the first embodiment, when the consent is not acquired, the operation of the test software is prohibited. Only the test software that ensures validity for performing the test can operate, and therefore, the driving systems 2, 2A, and 2B and the test method thereof suitable for performing performance improvement can be provided.

### Second Embodiment

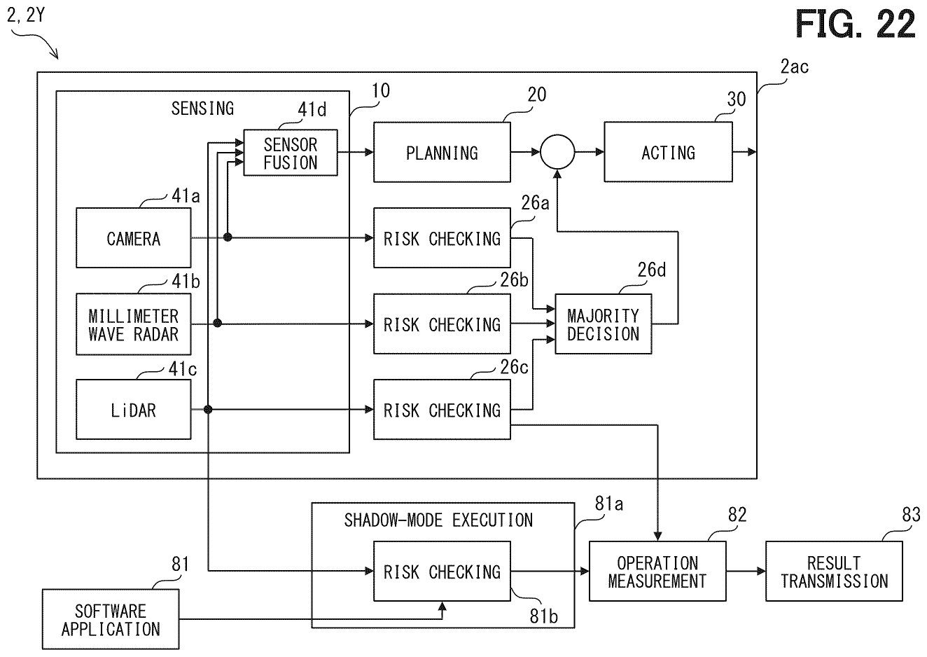

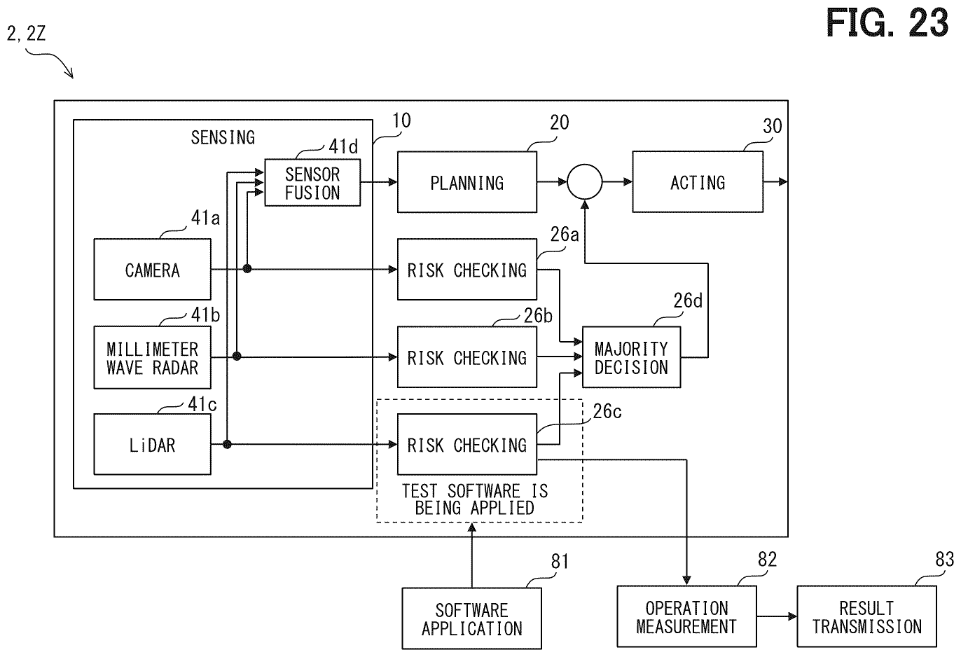

As illustrated in FIGS. 22 and 23, a second embodiment is a modification example of the first embodiment. The second embodiment will be described focusing on a difference from the first embodiment.

In the second embodiment, the software application unit 81 controls the HMI device 70 of the vehicle 1 to provide a user interface UIF that allows the user to set a test mode in which participation is accepted in advance, before the acquisition timing of the test consent. The test mode includes a test using a shadow-mode, a test using a redundant system, a test of an HMI, and the like.

In the test using the shadow-mode as one aspect of the test, the test software operates in parallel behind the scenes against the software operating according to the currently applied formula. The output result of the test software is not reflected in the behavior of the vehicles TTA and TTB. However, the test software can be verified by executing the same input as the input to the actual software on the test software and evaluating the output of the test software by an index related to safety.

In FIG. 22, a configuration is adopted in which a driving system 2Y as a specific example of the systems 2A and 2B applicable to the vehicles TTA and TTB is separated into an actual operation unit 2ac and a shadow-mode execution unit 81a. The actual operation unit 2ac and the shadow-mode execution unit 81a may be configured such that, for example, pieces of hardware are separate and independent. For example, a computer including a memory and a processor constituting the shadow-mode execution unit 81a may be provided separately from a main computer of the processing system 50. The actual operation unit 2ac and the shadow-mode execution unit 81a may share, for example, hardware resources. In this case, in a computer in which a computer program for the actual operation unit 2ac in the processing system 50 is incorporated, a computer program for the shadow-mode execution unit 81a is incorporated separately from the computer program for the actual operation unit 2ac to execute the process.

The actual operation unit 2ac is configured to reflect the process on at least one of the HMI, the V2X communication, and the behavior of the actual vehicles TTA and TTB. That is, a series of configurations described in the architecture of the driving system 2 described above is provided. The actual operation unit 2ac may include, for example, a redundant system. On the other hand, the shadow-mode execution unit 81a is configured to restrict the process from being reflected in the HMI and the behavior of the actual vehicles TTA and TTB. The shadow-mode execution unit 81a can provide information on the operation of the test software for the probe data collection by the server 96, which is not directly reflected in the HMI and behavior of the vehicles TTA and TTB.

FIG. 23 illustrates an example in which the shadow-mode is used to improve one risk checking unit 26c among the multiple risk checking units 26a, 26b, and 26c constituting the redundant system in the actual operation unit 2ac. In this example, the shadow-mode execution unit 81a includes a risk checking unit 81b corresponding to the risk checking unit 26c on the actual operation unit 2ac side. This risk checking unit 81b is different from the risk checking unit 26c on the actual operation unit 2ac side. The test software in a test executed for safety improvement is applied to the risk checking unit 81b by the software application unit 81.

The risk checking unit 81b is configured to receive the same information at substantially the same timing as the risk checking unit 26c on the actual operation unit 2ac side. The sensing result of the LiDAR 41c is input to the risk checking unit 26c, and therefore, the same sensing result of the LiDAR 41c is also input to the risk checking unit 81b.

The operation measurement unit 82 measures at least one of the data indicating the situation, the checking result of the situation (including the checking results of the risk), and the derived proper response, which are output by the risk checking unit 81b on the shadow-mode execution unit 81a side. The operation measurement unit 82 may further measure at least one of the data indicating the situation, the checking result of the situation, and the derived proper response, which are output by the risk checking unit 26c on the actual operation unit 2ac side. In this case, the operation measurement unit 82 may detect a difference between the output of the shadow-mode execution unit 81a and the output of the actual operation unit 2ac.

The result transmission unit 83 may transmit the outputs of the risk checking units 26c and 81b obtained by the operation measurement unit 82 to the server 96 as they are. The outputs of the risk checking units 26c and 81b obtained by the operation measurement unit 82 may be converted according to the format of the evaluation index set in the test. The result transmission unit 83 may transmit the converted data to the server 96.

In a test using a redundant system as another aspect of the test, test software is temporarily applied to one of a plurality of systems forming the redundant system. For example, in the case of a driving system including a redundant system of triple redundancy majority decision, even if one system to which the test software is applied outputs an error (a non-optimal solution for safety), the error due to the test software is rejected by the other two systems. Even in the case of a driving system including a dual-redundant system, a test using the redundant system can be performed as long as safety can be ensured by the remaining one system in the functionality of the test software to be tested.

FIG. 23 illustrates a driving system 2Z as a specific example of the systems 2A and 2B applicable to the vehicles TTA and TTB. In this driving system 2Z, an example in which a test is performed in order to improve one risk checking unit 26c among the multiple risk checking units 26a, 26b, and 26c is illustrated. In this example, the test software is temporarily applied to the risk checking unit 26c as a test target by the software application unit 81.

The sensing result of LiDAR 41c is input to the risk checking unit 26c as in the case of non-test periods. The checking results of the risk from the risk checking unit 26c based on the test software are aggregated by the majority decision provided by the majority decision unit 26d as in non-test periods. The output from the risk checking unit 26c is provided to the operation measurement unit 82. The risk checking unit as a test target may be the risk checking unit 26a to which the sensing result of the camera 41a is input or the risk checking unit 26b to which the sensing result of the millimeter wave radar 41b is input, instead of the risk checking unit 26c to which the sensing result of the LiDAR 41c is input.

The operation measurement unit 82 measures at least one of the data indicating the situation, the checking result of the situation (including the checking results of the risk), and the derived proper response, which are output by the risk checking unit 26c.

The result transmission unit 83 may transmit the outputs of the risk checking units 26c and 81b obtained by the operation measurement unit 82 to the server 96 as they are. The outputs of the risk checking units 26c and 81b obtained by the operation measurement unit 82 may be converted according to the format of the evaluation index set in the test. The result transmission unit 83 may transmit the converted data to the server 96.

The test using the redundant system may be performed on a vehicle capable of implementing level 4 automated driving by limiting at least one of the time and environment for operating the test software. This limitation makes it possible to minimize the risk caused by the operation of the test software. For example, execution time of the test may be limited only to daytime when the detection performance of the camera is high. For example, the execution environment of the test may be limited only to fine weather in which the detection performance of the camera is high. For example, the execution environment of the test may be limited to a case where assistance of an external operator capable of remotely driving the vehicle 1 can be obtained via the communication system 43.

The test using the redundant system may be conducted without limiting the time and the environment in a system having a triple-redundant system. The system having a triple-redundant system can be adopted, for example, in the driving systems 2A and 2B of vehicles capable of implementing automated driving at level 3 and the driving systems 2A and 2B of vehicles used for mobility as a service (MaaS) among vehicles capable of implementing automated driving at level 4.

In the test of the HMI as another aspect of the test, for example, the content actually presented to the information presentation device 70b is changed. It is necessary to evaluate the interaction between the actual interface and the user, and therefore, the test of the HMI is not suitable for the test using the shadow-mode and the test using the redundant system. Therefore, the test of the HMI is handled as a mode different from the test using the shadow-mode and the test using the redundant system.

The test mode may be set by the user, for example, during purchase of the vehicle 1 or during initial activation. The setting of the test mode may be set by the user at any timing through a screen of the information presentation device 70b also serving as the operation input device 70a that can be touch-operated, such as a CID. The setting information of the test mode is transmitted from the software application unit 81 of the driving system 2 to the test management unit 97a of the server 96.

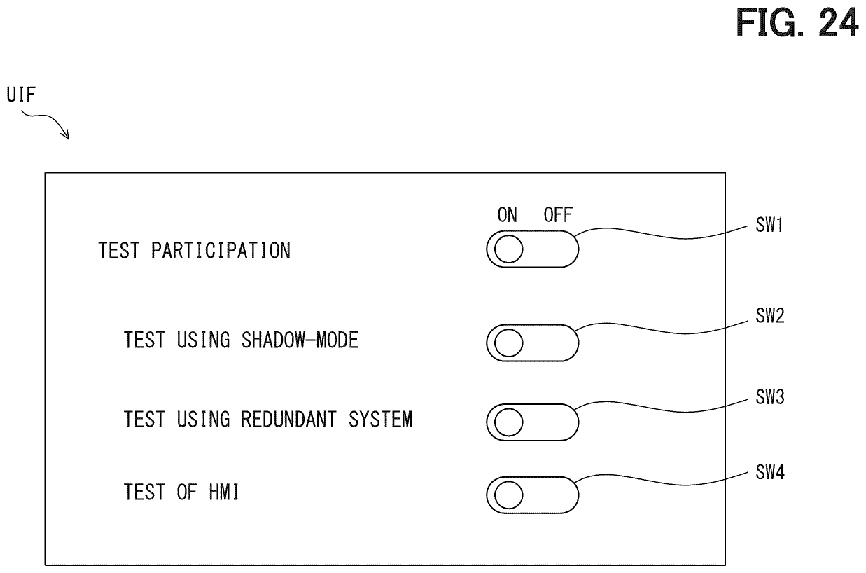

FIG. 24 shows a display example of a setting screen in the user interface UIF. In this example, in order to set the test mode, the software application unit 81 may display a test participation switch SW1 and individual switches SW2 to SW4 of each mode on the information presentation device 70b that also serves as the operation input device 70a through the HMI output unit 71. The test participation switch SW1 is a switch for indicating whether the user intends to participate in the test itself when the management system MS plans the test. When the test participation switch SW1 is set to the off state, that is, when the user indicates an intention not to participate in the test, the individual switches SW2 to SW4 of each aspect may be turned off in conjunction with the test participation switch SW1. When the test participation switch SW1 is set to the on state, that is, when the user indicates an intention to participate in the test, the individual switches SW2 to SW4 of each aspect may be switchable by the user.

The individual switches SW2 to SW4 of each aspect are individually displayed corresponding to each of the test using the shadow-mode, the test using the redundant system, and the test of the HMI. When the individual switches SW2 to SW4 are set to the off state, the vehicle 1 is excluded from the selection of the test target vehicle even if the test management unit 97a in the server 96 plans the test in the mode corresponding to this switch. That is, the setting information of the switches SW1 to SW4 is provided to the server 96, and the test management unit 97a selects the test target vehicle so that the vehicle 1 that cannot obtain the consent of the user is excluded from the test target vehicles based on the setting information. For the excluded vehicle 1, the test consent request and acquisition in conjunction with the timing of the authority transfer are not conducted.

When the individual switches SW2 to SW4 are set to the on state and the test management unit 97a plans the test in the mode corresponding to this switch, the vehicle 1 may be selected as the test target vehicle. When the vehicle 1 is selected as the test target vehicle, the software application unit 81 acquires the test consent of the user described in the first embodiment again.

According to the second embodiment described above, the HMI device 70 of the vehicle 1 is controlled to provide the user interface UIF that allows the user to set multiple test modes accepted by the user before the timing of requesting the consent of the user. With respect to the test in the test mode that is not accepted, the request for consent at the timing of authority transfer is not required, and thus the inconvenience felt by the user can be reduced.

According to the second embodiment, the user interface UIF includes the multiple individual switches SW2 to SW4 that allow the user to individually set whether to accept each of the multiple test modes. The multiple individual switches SW2 to SW4 facilitate customization of the test mode by the user.

According to the second embodiment, the user interface UIF includes the participation switch SW1 that allows the user to individually set whether to participate in the test itself. The user can set whether to participate in the test by operating one switch.

### Other Embodiments

Although a plurality of embodiments are described above, the present disclosure is not construed as being limited to these embodiments, and can be applied to various embodiments and combinations within a scope that does not depart from the gist of the present disclosure.

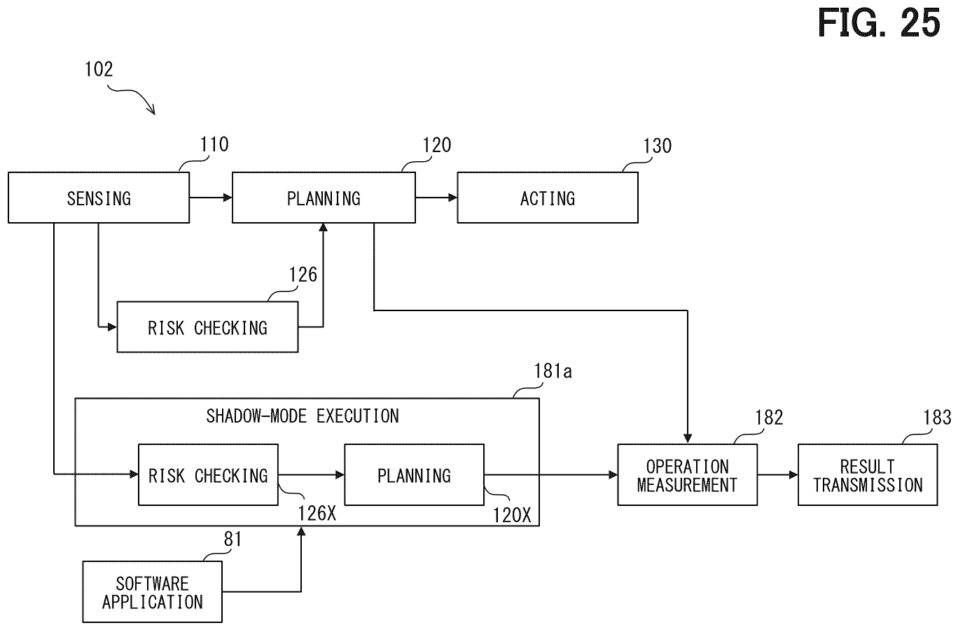

As another embodiment, as illustrated in FIG. 25, a risk checking unit 126 may not derive a proper response, and may be mounted specifically for a risk checking functionality. In this example, the risk checking unit 126 acquires situation data from a sensing unit 110, checks a risk with respect to a behavior of a safety-related object based on the situation data, and outputs a checking result to the planning unit 120. The planning unit 120 plans driving of the vehicles TTA and TTB according to the checking result acquired from the risk checking unit 126. The software included in the risk checking unit 126 of the driving system 102 can be tested using the shadow-mode. The test consent in the test may be acquired in conjunction with the state transition or the authority transfer as described in the first and second embodiments.

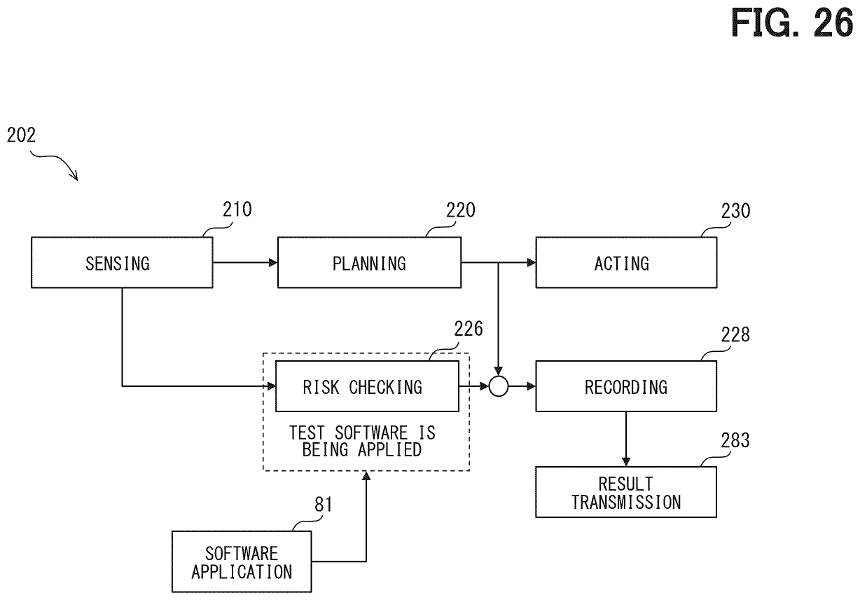

As another embodiment, as illustrated in FIG. 26, a risk checking unit 226 may be mounted specifically for a recording functionality, not for use in deriving driving and an action of the vehicle 1, but for use in subsequent verification and validation of a driving system 202. In this example, the risk checking unit 226 provides a checking result to a recording unit 228. The recording unit 228 organizes the processing result by the planning unit 220 and the checking result by the risk checking unit 226, and executes recording sequentially or periodically. The recording may be recording to the on-board storage medium 55c. For the software included in the risk checking unit 226 of the driving system 202, the test may not be executed using the shadow-mode, and the test may not be executed using the redundant system. The test consent in the test may be acquired in conjunction with the state transition or the authority transfer as described in the first and second embodiments.

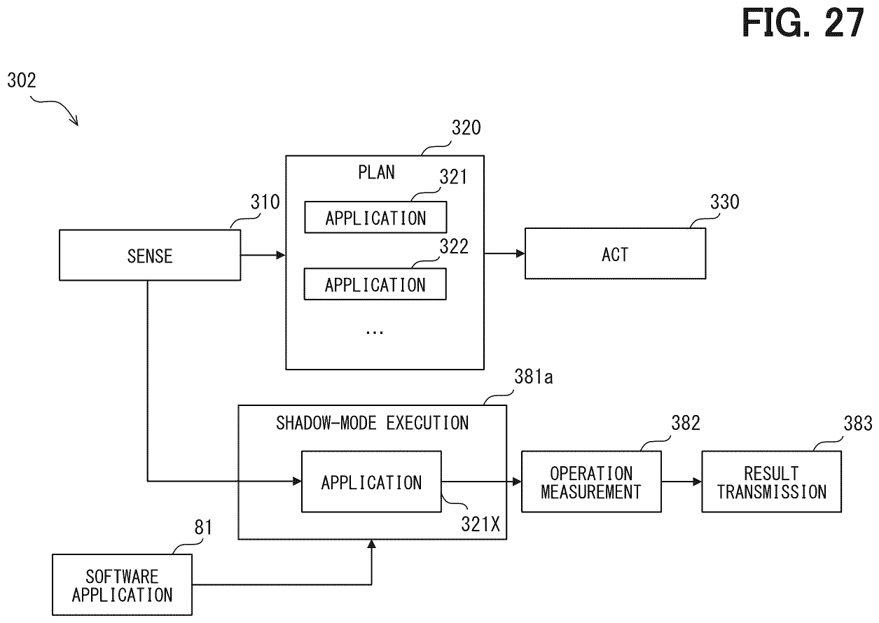

As another embodiment, as illustrated in FIG. 27, in a driving system 302, there is no risk checking unit provided independently of a sensing unit 310, a planning unit 320, and an acting unit 330. Software included in one specific application 321 of such a driving system 302 may be tested using the shadow-mode. The test consent in the test may be acquired in conjunction with the state transition or the authority transfer as described in the first and second embodiments.

As another embodiment, the management system MS may test one piece of test software for improving safety. When one piece of test software is tested and it is determined that the test software does not have higher performance than the software being applied, the improvement of the driving system may be stopped. When an improved version of the test software is provided, the management system MS may perform the test again using the improved version. The test software may improve performance other than safety.

As another embodiment, the test consent may be required from the user in conjunction with the timing of transition from the off state M1 to the standby/ready state M2 illustrated in FIG. 10. For example, when the state transitions from the off state M1 to the standby/ready state M2 in response to the user turning on the automated driving switch, the on operation of the automated driving switch may also consent.

The vehicles 1, TTA, and TTB on which each of the driving systems 2, 2A, 2B, 2Y, 2Z, 102, 202, and 302 is mounted are not limited to general private cars, and may be a rental vehicle, a manned taxi vehicle, a ride-sharing vehicle, a freight vehicle, a bus, and the like. The vehicles 1, TTA, and TTB may be right-hand drive vehicles or left-hand drive vehicles. A traffic environment in which the vehicles 1, TTA, and TTB travel may be a traffic environment in which left-hand traffic is the norm or a traffic environment in which right-hand traffic is the norm. The driving systems 2, 2A, 2B, 2Y, 2Z, 102, 202, and 302 according to the present disclosure may be appropriately optimized in consideration of road traffic laws and customs of each country and region, police investigations, prosecutions, criminal and civil lawsuits regarding traffic accidents, and the like.

The control unit and methods described in the present disclosure may be implemented by a dedicated computer comprising a processor programmed to execute one or more functions embodied by a computer program. Alternatively, the apparatus and methods described in the present disclosure may be implemented by dedicated hardware logic circuits. Further, the apparatus and methods described in the present disclosure may be implemented by one or more dedicated computers configured by a combination of a processor that executes a computer program and one or more hardware logic circuits. The computer program may be stored as instructions executable by a computer on a non-transitory, computer-readable tangible recording medium.

### Disclosure of Technical Ideas

This specification discloses a plurality of technical ideas as set forth in the following disclosure.

### (Technical Idea 1)

A driving system to be mounted on a vehicle includes:
at least one processor; and at least one storage medium configured to store at least one piece of software. Automated driving is enabled by operating the software by the processor in a manner of allowing authority transfer between a system itself and a user, the processor is configured to execute requesting consent of the user to perform a test on test software for improving the software, and operating the test software when the consent of the user is acquired, and in requesting consent of the user, the processor requests the consent of the user in conjunction with a timing of the authority transfer.

### (Technical Idea 2)

In the driving system according to Technical Idea 1,
the test is a test of a functionality related to execution of a dynamic driving task by the user, and
in requesting consent of the user, the processor requests the consent of the user in conjunction with a timing of the authority transfer from the system itself to the user.

### (Technical Idea 3)

In the driving system according to Technical Idea 2,
in requesting consent of the user, the processor regards, as acquisition of the consent of the user, contact with an operation input device for controlling a motion actuator that causes the vehicle to move when the user starts the dynamic driving task.

### (Technical Idea 4)

In the driving system according to Technical Idea 2,
when the timing of the authority transfer from the system itself to the user occurs due to exit of an operational design domain set in advance in the system itself,
in requesting consent of the user, the processor regards, as acquisition of the consent, contact with an operation input device for controlling a motion actuator that causes the vehicle to move when the user starts fallback of the dynamic driving task.

### (Technical Idea 5)

In the driving system according to Technical Idea 1,
the test is a test of a functionality related to a dynamic driving task by the system itself, and
in requesting consent of the user, the processor requests the consent of the user in conjunction with a timing of the authority transfer from the user to the system itself.

### (Technical Idea 6)

In the driving system according to any one of Technical Ideas 1 to 5,
the processor is further configured to control an HMI device of the vehicle to provide a user interface that allows the user to set a plurality of test modes accepted by the user before a timing of requesting the consent of the user to the execution of the test.

### (Technical Idea 7)

In the driving system according to Technical Idea 6,
the user interface includes a plurality of individual switches that allow the user to individually set whether to accept each of the plurality of test modes.

### (Technical Idea 8)

In the driving system according to Technical Idea 6 or 7,
the user interface includes a participation switch that allows the user to set whether to participate in the test itself.

### (Technical Idea 9)

In the driving system according to any one of Technical Idea 1 to 8,
the processor is configured to prohibit an operation of the test software when the consent is not acquired.

### (Technical Idea 10)

A test method for conducting, in a driving system to be mounted on a vehicle that includes at least one processor and at least one storage medium configured to store at least one piece of software, and that is configured to enable automated driving by operating the software by the processor in a manner of allowing authority transfer between a system itself and a user, a test regarding the software by the processor, is provided. The test method includes:
requesting, in conjunction with a timing of the authority transfer, consent of the user to perform a test on test software for improving the software;
acquiring the consent of the user by sensing an operation of the user on an operation input device of the vehicle in response to the request;
operating the test software when the consent of the user is acquired; and
prohibiting an operation of the test software when the consent of the user is not acquired.

### (Technical Idea 11)

A management system for managing a driving system the management system includes: a plurality of vehicles each equipped with the driving system; and a server communicably connected to the plurality of vehicles.

Each driving system is configured to enable automated driving by operating software in a manner of allowing authority transfer between a system itself and a user. The server is configured to execute setting test software to be tested on each driving system, and transmitting the test software to each driving systems. Each driving system is configured to execute requesting, in conjunction with a timing of the authority transfer, consent of the user to execution of a test on the test software received from the server, and operating the test software when the consent of the user is acquired.

According to this technical idea, the consent of the user to the conduction of the test of the test software is requested in conjunction with the timing of the authority transfer. That is, the consent to the test software to be used after the authority transfer between the driving system and the user can be acquired together with the authority transfer. Therefore, the validity of conducting the test can be ensured while reducing the inconvenience felt by the user for acquiring the consent. Therefore, a management system suitable for improving the performance of the driving system can be provided.

### (Technical Idea 12)

A management system for managing a driving system includes: a plurality of vehicles each equipped with the driving system; and a server communicably connected to the plurality of vehicles.

Each driving system is configured to execute controlling an HMI device of the vehicle so as to provide a user interface that allows a user to set a mode of a test accepted by the user of the vehicle, and transmitting setting information set by the user using the user interface to the server. The server is configured to execute acquiring the setting information from each of the vehicles, selecting a test target vehicle from the plurality of vehicles, and setting test software for testing the driving system of the test target vehicle among the plurality of vehicles, and transmitting the test software to each driving system, in selection of the test target vehicle, the server excludes, from the test target vehicle, the vehicle for which the consent of the user cannot be obtained based on a mode of the test assumed for the test and the setting information.

According to this technical idea, the HMI device of the vehicle is controlled so as to provide the user interface capable of setting the mode of the test accepted by the user. For the test in the test mode that is not accepted, the vehicle is excluded from the test target vehicles. That is, the user is not requested to agree with the execution of the test in the test mode that is not accepted, and therefore, the inconvenience felt by the user can be reduced. For the management system, the process for the test that cannot obtain the consent of the user can be restricted, and therefore, the processing load can be reduced.

### (Technical Idea 13)

A server includes at least one processor and communicably connected to a plurality of vehicles each equipped with a driving system.

The processor is configured to execute acquiring, from each of the vehicles, setting information set by a user for a mode of a test accepted by the user, selecting a test target vehicle from the plurality of vehicles, setting test software to be tested on the driving system of the test target vehicle among the plurality of vehicles, and transmitting the test software to each driving system. In the selection of the test target vehicle, the processor excludes, from the test target vehicle, a vehicle for which consent of the user cannot be obtained, based on the mode of the test assumed in the test and the setting information.

According to this technical idea, the vehicle for which the consent of the user cannot be obtained is excluded from the test target vehicle based on the setting information on the mode of the test accepted by the user. That is, for the management system, the process for the test for which the consent of the user cannot be obtained can be restricted, and therefore, the processing load can be reduced.

What is claimed is:

1. A driving system to be mounted on a vehicle, the driving system comprising:
at least one processor; and
at least one storage medium configured to store at least one piece of software,
wherein
automated driving is enabled by operating the software by the processor in a manner of allowing authority transfer between a system itself and a user,
the processor is configured to execute
requesting consent of the user to perform a test on test software for improving the software, and
operating the test software when the consent of the user is acquired, and
in requesting consent of the user, the processor requests the consent of the user in conjunction with a timing of the authority transfer.

2. The driving system according to claim 1, wherein
the test is a test of a functionality related to execution of a dynamic driving task by the user, and
in requesting consent of the user, the processor requests the consent of the user in conjunction with a timing of the authority transfer from the system itself to the user.

3. The driving system according to claim 2, wherein
in requesting consent of the user, the processor regards, as acquisition of the consent, contact with an operation input device for controlling a motion actuator that causes the vehicle to move when the user starts the dynamic driving task.

4. The driving system according to claim 2, wherein
when the timing of the authority transfer from the system itself to the user occurs due to exit from an operational design domain set in advance in the system itself,
in requesting consent of the user, the processor regards, as acquisition of the consent, contact with an operation input device for controlling a motion actuator that causes the vehicle to move when the user starts fallback of the dynamic driving task.

5. The driving system according to claim 1, wherein
the test is a test of a functionality related to a dynamic driving task by the system itself, and
in requesting consent of the user, the processor requests the consent of the user in conjunction with a timing of the authority transfer from the user to the system itself.

6. The driving system according to claim 1, wherein
the processor is further configured to control an HMI device of the vehicle to provide a user interface that allows the user to set a plurality of test modes accepted by the user before a timing of requesting the consent of the user to the execution of the test.

7. The driving system according to claim 6, wherein
the user interface includes a plurality of individual switches that allow the user to individually set whether to accept each of the plurality of test modes.

8. The driving system according to claim 6, wherein
the user interface includes a participation switch that allows the user to set whether to participate in the test itself.

9. The driving system according to claim 1, wherein
the processor is configured to prohibit an operation of the test software when the consent is not acquired.

10. A test method for conducting, in a driving system to be mounted on a vehicle that includes at least one processor and at least one storage medium configured to store at least one piece of software, and that is configured to enable automated driving by operating the software by the processor in a manner of allowing authority transfer between a system itself and a user, a test regarding the software by the processor, the test method comprising:
requesting, in conjunction with a timing of the authority transfer, consent of the user to perform a test on test software for improving the software;
acquiring the consent of the user by sensing an operation of the user on an operation input device of the vehicle in response to the request;
operating the test software when the consent of the user is acquired; and
prohibiting an operation of the test software when the consent of the user is not acquired.
